(19) United States
(12) Patent Application Publication
(10) Pub. No.: US 2024/0005165 A1
(43) Pub. Date: Jan. 4, 2024

(54) MACHINE LEARNING MODEL TRAINING METHOD, PREDICTION METHOD THEREFOR, APPARATUS, DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Qiaolin XIA, Shebnzhen (CN); Wenjie Li, Shenzhen (CN); Hao Cheng, Shenzhen (CN); Shutao Xia, Shenzhen (CN)

(21) Appl. No.: 18/369,716

(22) Filed: Sep. 18, 2023

Related U.S. Application Data
(63) Continuation of application No. PCT/CN2022/134720, filed on Nov. 28, 2022.

(30) Foreign Application Priority Data
Feb. 24, 2022 (CN) 202210172210.3

(51) Int. Cl. G06N 3/084; G06N 3/047

(52) U.S. Cl. CPC G06N 3/084; G06N 3/047

(57) ABSTRACT

A machine learning model training method performed by a computer device acting as an active-party device is provided. The method includes: coding and encrypting a first object feature in the sample pairs provided by the active-party device using an active-party coding model to obtain an active-party first encrypted coding result; acquiring N passive-party first encrypted coding results correspondingly sent by N passive-party devices in combination with a second object feature in the sample pairs; splicing the active-party first encrypted coding result and the N passive-party first encrypted coding results to obtain a first spliced encrypted coding result, and applying the first spliced encrypted coding result to a first prediction model to obtain a first prediction probability; and causing an update of parameters of the different models based on a first difference between the first prediction probability and a first prediction task label of the sample pairs.

### CROSS-REFERENCE TO RELATED APPLICATIONS

This application is a continuation application of PCT Patent Application No. PCT/CN2022/134720, entitled “MACHINE LEARNING MODEL TRAINING METHOD, PREDICTION METHOD THEREFOR, APPARATUS, DEVICE, COMPUTER-READABLE STORAGE MEDIUM, AND COMPUTER PROGRAM PRODUCT” filed on Nov. 28, 2022, which is based upon and claim priority to Chinese Patent Application No. 202210172210.3, entitled “MACHINE LEARNING MODEL TRAINING METHOD, PREDICTION METHOD THEREFOR, APPARATUS, AND DEVICE” filed on Feb. 24, 2022, all of which is incorporated by reference in their entireties.

### FIELD OF THE TECHNOLOGY

This application relates to artificial intelligence (AI) technologies, and particularly, to a machine learning model training method, a prediction method therefor, an apparatus, an active-party device, a computer-readable storage medium, and a computer program product.

### BACKGROUND OF THE DISCLOSURE

AI is a comprehensive technology of computer science for studying design principles and implementation methods for various intelligent machines, to enable the machines to have perception, inference, and decision-making functions. The AI technology is a comprehensive discipline, and relates to wide fields such as a natural language processing technology and machine learning/deep learning. With development of technologies, the AI technology will be applied to more fields and play an increasingly important role.

With the development of the AI technology, a concept of “vertical federated learning (VFL)” emerges. The VFL means that when there are a small quantity of overlapping object features but a large quantity of overlapping objects between training participants, the same objects with different object features and the object features in the training participants are selected to perform joint machine learning model training.

In the related art, the VFL can be performed only based on cross sample data between the training participants that has a target task label. In an actual application scenario, there is usually a large amount of cross sample data between the training participants, but only a small amount of sample data with the target task label can be used for learning and training. Moreover, only a target task label within a specific time limit is usually used. This further reduces a scale of cross sample data actually available to the training participants. If only the sample data within the specific time limit and with the target task label is used for training, a problem of over-fitting is easy to occur, making an effect of a trained model poor.

### SUMMARY

Embodiments of this application provide a machine learning model training method, a prediction method therefor, an apparatus, an active-party device, a computer-readable storage medium, and a computer program product, to introduce a first prediction task label in addition to a target prediction task label for model training, so that a trained machine learning model has a good generalization capability, thereby improving accuracy of a prediction result of the machine learning model.

Technical solutions in the embodiments of this application are implemented as follows:

An embodiment of this application provides a machine learning model training method performed by a computer device acting as an active-party device, the method including:
coding and encrypting a first object feature in a plurality of sample pairs provided by the active-party device using an active-party coding model to obtain an active-party first encrypted coding result, the plurality of sample pairs comprising a set of positive sample pairs and a set of negative sample pairs;
acquiring N passive-party first encrypted coding results correspondingly sent by N passive-party devices, N being an integral constant, N≥1, the N passive-party first encrypted coding results being determined based on N passive-party coding models in combination with a second object feature in the plurality of sample pairs provided by the N passive-party devices;
splicing the active-party first encrypted coding result and the N passive-party first encrypted coding results to obtain a first spliced encrypted coding result, and applying the first spliced encrypted coding result to a first prediction model to obtain a first prediction probability, the first prediction probability being a probability indicating that the first and second object features in each of the plurality of sample pairs are from a same object;
performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices; and causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model.

An embodiment of this application provides an active-party device, including:
a memory, configured to store executable instructions; and
a processor, configured to implement, when executing the executable instructions stored in the memory, the machine learning model training method or the machine learning model-based prediction method provided in the embodiments of this application.

An embodiment of this application provides a non-transitory computer-readable storage medium. The computer-readable storage medium stores executable instructions, and the executable instructions, when executed by a processor, are used for implementing the machine learning model training method or the machine learning model-based prediction method provided in the embodiments of this application.

The embodiments of this application have the following beneficial effects:

The first prediction model is trained by using the object features provided by the active-party device and the passive-party device in the sample pair. Because the first prediction model is used for predicting the probability that the object features in the sample pair are from the same object, the first prediction model can make representation of object features of the same object in the active-party device and the passive-party device approximate to each other. Because the prediction task of the first prediction model is different from that of the second prediction model, the first prediction task label is also different from the second prediction task label. The first prediction task label reflects whether a plurality of object features are from the same object, and imposes no restriction on the object features used for training, that is, quantities of positive sample pairs and negative sample pairs used for training are very large. Therefore, introducing the first prediction task label that is different from a target prediction task label (namely, the second prediction task label) can expand a training scale and enable a trained machine learning model to have a good generalization capability, to improve accuracy of a prediction result of the machine learning model.

### BRIEF DESCRIPTION OF THE DRAWINGS

FIG. 1A is a schematic architectural diagram of a machine learning model training system 100 including an active-party device and passive-party devices according to an embodiment of this application.

FIG. 1B is a schematic architectural diagram of a machine learning model training system 100 including an active-party device, passive-party devices, and an intermediate-party device according to an embodiment of this application.

FIG. 2A is a schematic structural diagram of a server 200 including a machine learning model training apparatus according to an embodiment of this application.

FIG. 2B is a schematic structural diagram of a server 200 including a machine learning model-based prediction apparatus according to an embodiment of this application.

FIG. 3A is a schematic flowchart of steps 101 to 105 in a machine learning model training method according to an embodiment of this application.

FIG. 3B is a schematic flowchart of steps 1041A to 1045A in a machine learning model training method according to an embodiment of this application.

FIG. 3C is a schematic flowchart of steps 1031 to 1033 and steps 1041B to 1044B in a machine learning model training method according to an embodiment of this application.

FIG. 3D is a schematic flowchart of steps 1051 to 1055 in a machine learning model training method according to an embodiment of this application.

FIG. 3E is a schematic flowchart of steps 10551A to 10555A in a machine learning model training method according to an embodiment of this application.

FIG. 3F is a schematic flowchart of steps 10531 and 10532 and steps 10551B to 10554B in a machine learning model training method according to an embodiment of this application.

FIG. 4A is a schematic structural diagram of a machine learning model including an active party and a passive party according to an embodiment of this application.

FIG. 4B is a schematic structural diagram of a machine learning model including an active party, a passive party, and an intermediate party according to an embodiment of this application.

FIG. 4C is a schematic diagram of construction manners of a negative sample pair according to an embodiment of this application.

FIG. 5 is a schematic flowchart of a machine learning model-based prediction method according to an embodiment of this application.

FIG. 6 is a schematic diagram of object cross between an active-party device and a passive-party device according to an embodiment of this application.

FIG. 7 is a schematic diagram of construction manners of a positive sample pair and a negative sample pair according to an embodiment of this application.

FIG. 8A is a schematic structural diagram of a machine learning model in a pre-training phase according to an embodiment of this application.

FIG. 8B is a schematic structural diagram of machine learning models in a pre-training phase and a fine-tuning phase according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, the term “some embodiments” describes subsets of all possible embodiments, but it may be understood that “some embodiments” may be the same subset or different subsets of all the possible embodiments, and can be combined with each other without conflict.

In the following descriptions, the terms “first/second/third” are merely intended to distinguish between similar objects rather than indicating specific orders of the objects. It may be understood that, orders of the terms “first/second/third” may be interchanged if allowed, so that the embodiments of this application described herein can be implemented in an order other than that illustrated or described herein.

Unless otherwise defined, meanings of all technical and scientific terms used in this specification are the same as those usually understood by a person skilled in the art to which this application belongs. Terms used in this specification are merely intended to describe the objectives of the embodiments of this application, but are not intended to limit this application.

It can be understood that the embodiments of this application are related to data relevant to user information and the like. Applying the embodiments of this application to specific products or technologies needs to be permitted or allowed by users, and collection, use, and processing of the relevant data need to comply with relevant laws, regulations and standards of relevant countries and regions.

Before the embodiments of this application are further described in detail, nouns and terms in the embodiments of this application are described, and are applicable to the following explanations.

(1) VFL: is a machine learning framework for distributed learning. Under the premise of ensuring information security during data exchange, protecting privacy of terminal data and personal data, and ensuring legal compliance, efficient machine learning is performed between an active-party device and a plurality of passive-party devices with a large quantity of overlapping objects and a small quantity of overlapping object features.

(2) Active party: is a term in the VFL. In a VFL process, the active party trains a machine learning model based on label data and a training sample that are locally stored. An electronic device configured to train the machine learning model in the active party is referred to as an active-party device.

(3) Passive party: is also a term in the VFL. In the VFL process, the passive party trains the machine learning model based on a training sample that is locally stored. An electronic device configured to train the machine learning model in the passive party is referred to as a passive-party device.

(4) Intermediate party: also referred to as a coordinated party, is also a term in the VFL. In the VFL process, the active and passive parties may encrypt model training-related data and send the encrypted data to the intermediate party, and the intermediate party performs the VFL process. An electronic device configured to train the machine learning model in the intermediate party is referred to as an intermediate-party device.

(5) Homomorphic encryption algorithm: Data encrypted by using the homomorphic encryption algorithm is operated to obtain an output result, the output result is decrypted to obtain a decrypted result, and the decrypted result is the same as an output result obtained by operating the original data on which homomorphic encryption processing is not performed.

In the related art, the VFL can be performed only based on cross sample data between training participants that has a target task label. In an actual application scenario, there is usually a large amount of cross sample data between the training participants, but only a small amount of sample data with the target task label can be used for learning and training. This results in a data waste problem. Moreover, in many Internet service scenarios, during the VFL, there is a requirement for timeliness of the target task label, and usually, only a target task label within a specified short period of time from a current moment is used. This further reduces a scale of cross sample data actually available to the training participants. If only the sample data within the specified short period of time from the current moment and with the target task label is used for training, a problem of over-fitting is easy to occur, making an effect of a trained model poor.

The embodiments of this application can be implemented by using a cloud computing technology. Cloud computing is a computing mode, which distributes a computing task on a resource pool including a large quantity of computers, so that various application systems can obtain computing power, storage space, and information services as required. A network that provides resources is referred to as “cloud”. Users consider that the resources in the “cloud” can be infinitely expanded, and can be obtained and expanded at any time, used on demand, and paid according to use.

A basic capability provider of the cloud computing establishes a cloud computing resource pool (a cloud platform for short), and is generally referred to as an infrastructure-as-a-service platform. The infrastructure-as-a-service platform deploys various types of virtual resources in the resource pool for an external customer to choose and use. The cloud computing resource pool mainly includes: a computing device (which is a virtual machine, including an operating system), a storage device, and a network device.

According to logical function division, a platform-as-a-service layer may be deployed above the infrastructure-as-a-service layer, and a software-as-a-service layer is deployed above the platform-as-a-service layer; or the software-as-a-service may be directly deployed above the infrastructure-as-a-service. The platform-as-a-service is a platform on which software runs, such as a database and a network container. The software-as-a-service is a variety of service software, such as a web portal and a bulk SMS message sender. Generally, the software-as-a-service and the platform-as-a-service are upper layers relative to the infrastructure-as-a-service.

The embodiments of this application provide a machine learning model training method, a prediction method therefor, an apparatus, an electronic device (namely, an active-party device), a computer-readable storage medium, and a computer program product, to improve accuracy of a prediction result of a machine learning model.

An electronic device that is configured to train a machine learning model and that is provided in the embodiments of this application may be various types of terminal devices or servers. The server may be an independent physical server, a server cluster or a distributed system including a plurality of physical servers, or a cloud server providing a cloud computing service. The terminal may be a smartphone, a tablet computer, a notebook computer, a desktop computer, a smart speaker, a smartwatch, or the like, but is not limited thereto. The terminal and the server may be directly or indirectly connected through wired or wireless communication. This is not limited in this application.

An exemplary application of the electronic device that is configured to train the machine learning model and that is provided in the embodiments of this application is described below. The electronic device that is configured to train the machine learning model and that is provided in the embodiments of this application may be implemented as a server. An exemplary application of the electronic device implemented as the server is described below.

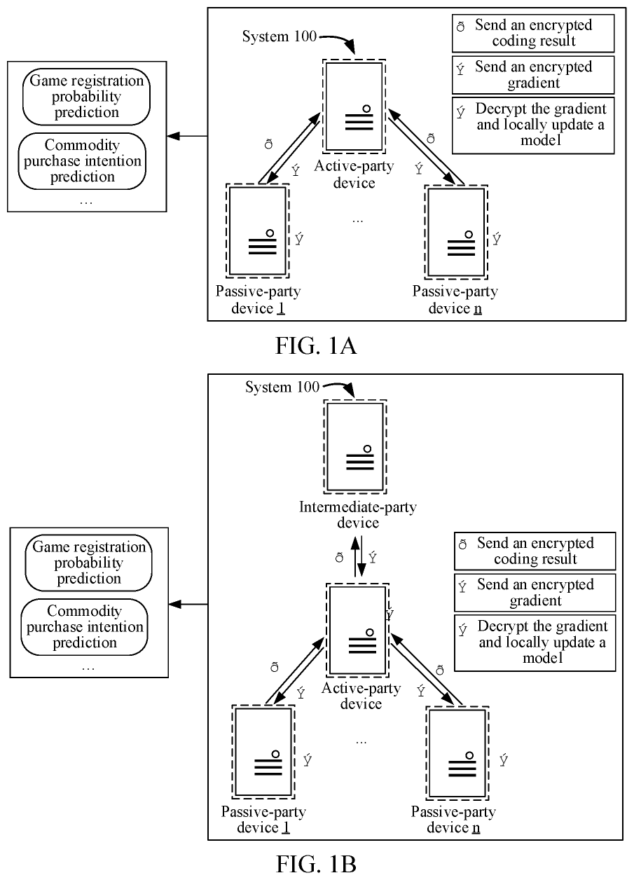

The machine learning model training method provided in the embodiments of this application may be completed by the server. FIG. 1A is a schematic architectural diagram of a machine learning model training system 100 including an active-party device and passive-party devices according to an embodiment of this application. The system includes the active-party device and a plurality of passive-party devices, where the plurality of passive-party devices are separately in a communication connection with the active-party device. Each passive-party device sends a passive-party encrypted coding result (namely, an encrypted coding result in FIG. 1A) to the active-party device, and the active-party device splices an active-party encrypted coding result and the plurality of passive-party encrypted coding results to obtain a spliced encrypted coding result. The active-party device obtains an encrypted gradient (namely, an encrypted gradient in FIG. 1A) of a parameter of each model based on a difference between the spliced encrypted coding result and a prediction task label, and updates a parameter of an active-party coding model based on an encrypted gradient of the parameter of the active-party coding model. Moreover, the active-party device sends an encrypted gradient of a parameter of each passive-party coding model to a corresponding passive-party device, so that the passive-party device updates the parameter of the corresponding passive-party coding model. The active-party device and the plurality of passive-party devices may be implemented as servers.

FIG. 1B is a schematic architectural diagram of a machine learning model training system 100 including an active-party device, passive-party devices, and an intermediate-party device according to an embodiment of this application, where the system includes the intermediate-party device, the active-party device, and a plurality of passive-party devices. Each passive-party device sends a passive-party encrypted coding result (namely, an encrypted coding result in FIG. 1B) to the active-party device, the active-party device sends an active-party encrypted coding result and the plurality of passive-party encrypted coding results to the intermediate-party device, and the intermediate-party device splices the received encrypted coding results to obtain a spliced encrypted coding result. The intermediate-party device obtains an encrypted gradient (namely, an encrypted gradient in FIG. 1B) of a parameter of each model based on a difference between the spliced encrypted coding result and a prediction task label, and sends the encrypted gradient to the active-party device. The active-party device updates a parameter of an active-party coding model based on an encrypted gradient of the parameter of the active-party coding model. Moreover, the active-party device sends an encrypted gradient of a parameter of each passive-party coding model to a corresponding passive-party device, so that the passive-party device updates the parameter of the corresponding passive-party coding model. The intermediate-party device, the active-party device, and the plurality of passive-party devices may be implemented as servers.

In some embodiments, the server may be an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The servers may be directly or indirectly connected through wired or wireless communication. This is not limited in the embodiments of this application.

The embodiments of this application may be implemented by using a blockchain technology. In some embodiments, a plurality of servers may form a blockchain network, and the servers are nodes in the blockchain network. The plurality of nodes run a smart contract for implementing the machine learning model training method and the prediction method therefor, and ensure data reliability in a training process and an application process by means of a consensus. In addition, a parameter of a machine learning model may be stored on chain, and an off-chain parameter of the machine learning model needs to be requested by an electronic device that uses the machine learning model from the blockchain network by invoking the smart contract. A parameter is delivered only when the plurality of nodes reach the consensus about the delivery. This avoids the parameter of the machine learning model being maliciously tampered with.

The embodiments of this application may also be applied to the field of maps and Internet of vehicles. In some embodiments, the machine learning model may be an intelligent voice assistant model in an in-vehicle scenario for responding to a voice command of a driver, including controlling a vehicle and running an application, for example, a music client, a video client, and a navigation client in an in-vehicle terminal.

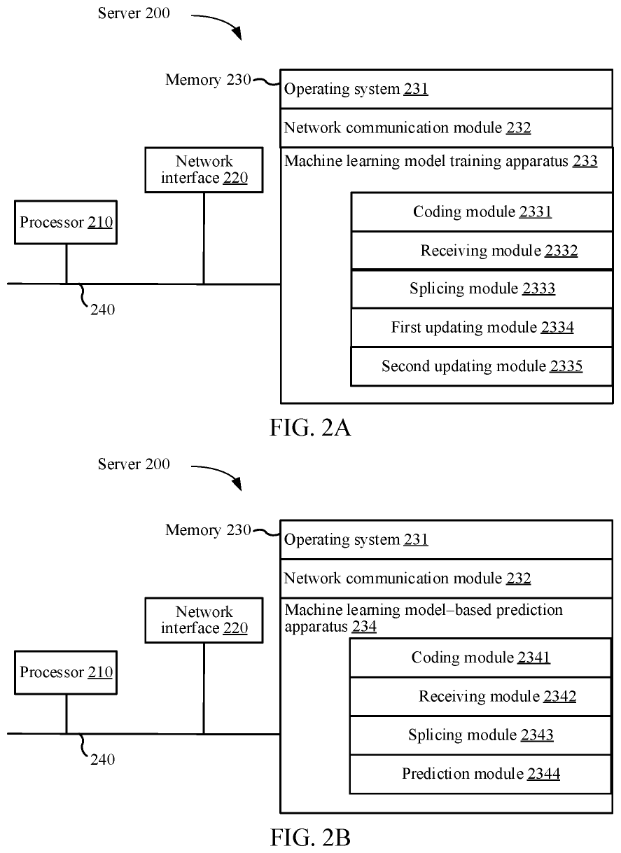

Next, FIG. 2A is a schematic structural diagram of a server 200 including a machine learning model training apparatus according to an embodiment of this application. The server 200 shown in FIG. 2A may be represented by the foregoing active-party device. The server 200 shown in FIG. 2A includes: at least one processor 210, a memory 230, and at least one network interface 220. The components in the server 200 are coupled together via a bus system 240. It may be understood that, the bus system 240 is configured to implement connection and communication between the components. The bus system 240 further includes a power bus, a control bus, and a status signal bus in addition to a data bus. However, for clear description, various buses are all marked as the bus system 240 in FIG. 2A.

The processor 210 may be an integrated circuit chip having a signal processing capability, for example, a general-purpose processor, a digital signal processor (DSP), or another programmable logic device, discrete gate, transistor logic device, or discrete hardware assembly. The general-purpose processor may be a microprocessor, any conventional processor, or the like.

The memory 230 may be removable or non-removable, or include both a removable part and a non-removable part. Exemplary hardware devices include a solid-state memory, a hard disk drive, an optical disk drive, and the like. In some embodiments, the memory 230 includes one or more storage devices physically far away from the processor 210.

The memory 230 includes a volatile memory or a nonvolatile memory, or may include the volatile memory and the nonvolatile memory. The nonvolatile memory may be a read-only memory (ROM), and the volatile memory may be a random access memory (RAM). The memory 230 described in this embodiment of this application aims to include any suitable type of memory.

In some embodiments, the memory 230 can store data to support various operations, and examples of the data include a program, a module, a data structure, or a subset or superset thereof. The following provides exemplary descriptions.

An operating system 231 includes system programs, for example, a framework layer, a core library layer, and a drive layer, used for processing various basic system services and executing hardware related tasks, and is configured to implement various basic services and process hardware based tasks.

A network communication module 232 is configured to connect to another computing device via one or more (wired or wireless) network interfaces 220. Exemplary network interfaces 220 include: Bluetooth, wireless fidelity (Wi-Fi), a universal serial bus (USB), and the like.

In some embodiments, the machine learning model training apparatus provided in the embodiments of this application may be implemented by software. FIG. 2A shows the machine learning model training apparatus 233 stored in the memory 230, where the apparatus 233 may be software in a form of a program, a plug-in, or the like, and includes the following software modules: a coding module 2331, a receiving module 2332, a prediction module 2333, a first updating module 2334, and a second updating module 2335. These modules are logical, and therefore may be arbitrarily combined or further split according to functions to be implemented.

FIG. 2B is a schematic structural diagram of a server 200 including a machine learning model-based prediction apparatus according to an embodiment of this application. The server 200 shown in FIG. 2B may be represented by the foregoing active-party device. The server 200 shown in FIG. 2B includes: at least one processor 210, a memory 230, and at least one network interface 220. The components in the server 200 are coupled together via a bus system 240. FIG. 2B shows the machine learning model-based prediction apparatus 234 stored in the memory 230, where the apparatus 234 may be software in a form of a program, a plug-in, or the like, and includes the following software modules: a coding module 2341, a receiving module 2342, a splicing module 2343, and a prediction module 2344. These modules are logical, and therefore may be arbitrarily combined or further split according to functions to be implemented.

The machine learning model training apparatus and the machine learning model-based prediction apparatus may be integrated into the same electronic device or separately integrated into different electronic devices. An electronic device for machine learning model training locally stores, after completing the model training, a trained machine learning model for prediction. In this case, the machine learning model training apparatus and the machine learning model-based prediction apparatus are integrated into the same electronic device. An electronic device for machine learning model training sends, after completing the model training, a trained machine learning model to another electronic device, and the another electronic device performs prediction by using the trained machine learning model. In this case, the machine learning model training apparatus and the machine learning model-based prediction apparatus are integrated into different electronic devices.

In some other embodiments, the machine learning model training apparatus and the machine learning model-based prediction apparatus that are provided in the embodiments of this application may be implemented by hardware. For example, the apparatus provided in the embodiments of this application may be a processor in a hardware decoding processor form, where the processor is programmed to perform the machine learning model training method provided in the embodiments of this application. For example, the processor in the hardware decoding processor form may use one or more application-specific integrated circuits (ASICs), DSPs, programmable logic devices (PLDs), complex PLDs (CPLDs), field-programmable gate arrays (FPGAs), or other electronic elements.

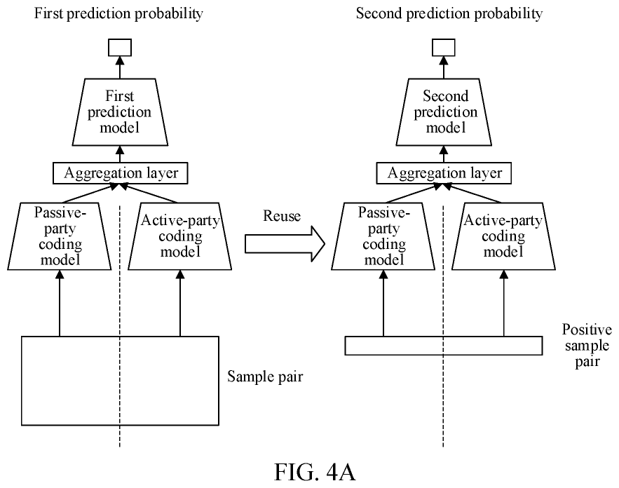

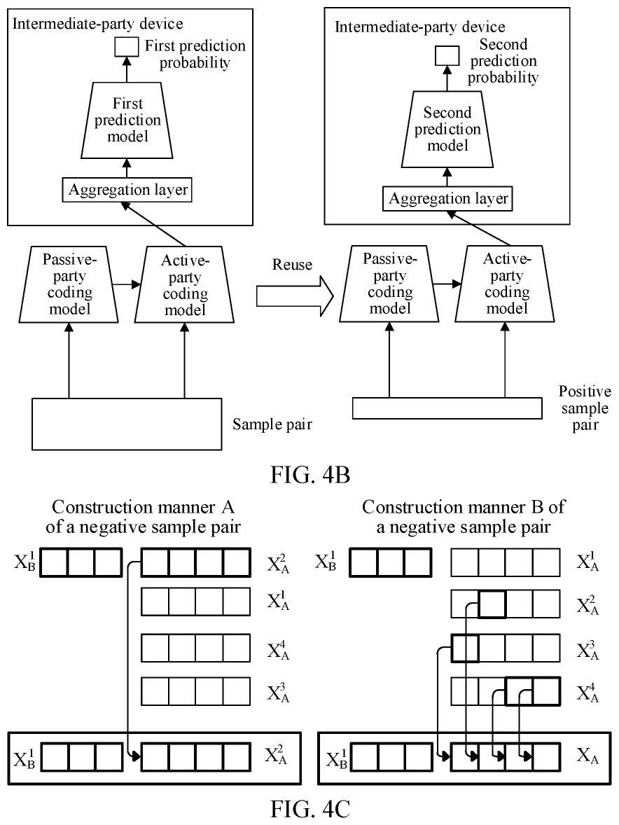

A structure of the machine learning model provided in the embodiments of this application is first described before the machine learning model training method provided in the embodiments of this application. FIG. 4A is a schematic structural diagram of a machine learning model including an active party and a passive party according to an embodiment of this application. The machine learning model shown in FIG. 4A includes an active-party coding model, a passive-party coding model, a first prediction model, and a second prediction model. For example, the active-party coding model and the passive-party coding model may be machine learning models such as deep neural network (DNN) models, and both the first prediction model and the second prediction model may be machine learning models such as linear regression models, logistic regression models, and gradient boosting tree models.

The following uses one passive-party device as an example for description.

An active-party device calls the active-party coding model to code a first object feature provided by the active-party device in a sample pair, to obtain an active-party first coding result; and encrypts the active-party first coding result to obtain an active-party first encrypted coding result. Similarly, the passive-party device calls the passive-party coding model to code an object feature (namely, a second object feature) provided by the passive-party device in the sample pair, to obtain a passive-party first coding result. After encrypting the passive-party first coding result, the passive-party device obtains a passive-party first encrypted coding result, and sends the passive-party first encrypted coding result to the active-party device.

The active-party device splices the active-party first encrypted coding result and the passive-party first encrypted coding result through an aggregation layer to obtain a first spliced encrypted coding result. The active-party device calls the first prediction model to predict the first spliced encrypted coding result to obtain a first prediction probability. Back propagation is performed based on a first difference between the first prediction probability and a first prediction task label to obtain an encrypted first gradient of a parameter of each model. The active-party device separately decrypts an encrypted first gradient of a parameter of the first prediction model and an encrypted first gradient of a parameter of the active-party coding model, and updates the parameters of the corresponding models based on corresponding decrypted first gradients. The encrypted first gradient of the parameter of each model is obtained by encrypting a first gradient of the parameter, for example, by using a homomorphic encryption algorithm. The first gradient of the parameter of the model is a vector. When the parameter of the model changes along a direction of the vector, an output result of the model changes the fastest. Moreover, the active-party device sends an encrypted first gradient of a parameter of the passive-party coding model to the passive-party device. The passive-party device decrypts the received encrypted first gradient of the parameter of the passive-party coding model, and updates the parameter of the passive-party coding model based on a decrypted first gradient. In this way, the parameter of each model is updated once. After training is performed for a maximum quantity of times or the first difference is less than a specified threshold, the first phase of training ends, and the second phase of training starts.

In the second phase of training, the active-party coding model and the passive-party coding model are an active-party coding model and a passive-party coding model that are obtained after the first phase of training ends. The second prediction model is a reinitialized model.

A training process in the second phase of training is the same as a training process in the first phase of training, but training data (which is a positive sample pair) in the second phase of training is different from training data (which includes the positive sample pair and a negative sample pair) in the first phase of training. A prediction task of the second prediction model is different from a prediction task of the first prediction model.

FIG. 4B is a schematic structural diagram of a machine learning model including an active party, a passive party, and an intermediate party according to an embodiment of this application. The machine learning model shown in FIG. 4B includes an active-party coding model, a passive-party coding model, a first prediction model, and a second prediction model. For example, the active-party coding model and the passive-party coding model may be machine learning models such as DNN models, and both the first prediction model and the second prediction model may be machine learning models such as linear regression models, logistic regression models, and gradient boosting tree models.

The following uses one passive-party device as an example for description.

An active-party device calls the active-party coding model to code a first object feature provided by the active-party device in a sample pair, to obtain an active-party first coding result; and encrypts the active-party first coding result to obtain an active-party first encrypted coding result. Similarly, the passive-party device calls the passive-party coding model to code a second object feature provided by the passive-party device in the sample pair, to obtain a passive-party first coding result. After encrypting the passive-party first coding result, the passive-party device obtains a passive-party first encrypted coding result, and sends the passive-party first encrypted coding result to the active-party device.

The active-party device sends the active-party first encrypted coding result and the passive-party first encrypted coding result to an intermediate-party device. The intermediate-party device splices the active-party first encrypted coding result and the passive-party first encrypted coding result through an aggregation layer to obtain a first spliced encrypted coding result. The intermediate-party device calls the first prediction model to predict the first spliced encrypted coding result, to obtain a first prediction probability. Back propagation is performed based on a first difference between the first prediction probability and a first prediction task label to obtain an encrypted first gradient of a parameter of each model, and the encrypted first gradient is sent to the active-party device.

The active-party device separately decrypts a received encrypted first gradient of a parameter of the first prediction model and a received encrypted first gradient of a parameter of the active-party coding model, and updates the parameters of the corresponding models based on corresponding decrypted first gradients. Moreover, the active-party device sends a received encrypted first gradient of a parameter of the passive-party coding model to the passive-party device. The passive-party device decrypts the received encrypted first gradient of the parameter of the passive-party coding model, and updates the parameter of the passive-party coding model based on a decrypted first gradient. In this way, the parameter of each model is updated once. After training is performed for a maximum quantity of times or the first difference is less than a specified threshold, the first phase of training ends, and the second phase of training starts.

In the second phase of training, the active-party coding model and the passive-party coding model are an active-party coding model and a passive-party coding model that are obtained after the first phase of training ends. The second prediction model is a reinitialized model.

A training process in the second phase of training is the same as a training process in the first phase of training, but training data (which is a positive sample pair) in the second phase of training is different from training data (which includes the positive sample pair and a negative sample pair) in the first phase of training. A prediction task of the second prediction model is different from a prediction task of the first prediction model.

The following describes the machine learning model training method provided in the embodiments of this application with reference to the exemplary application and implementation of the server provided in the embodiments of this application, where the method is applied to an active-party device. It may be understood that the following method may be performed by the foregoing server 200.

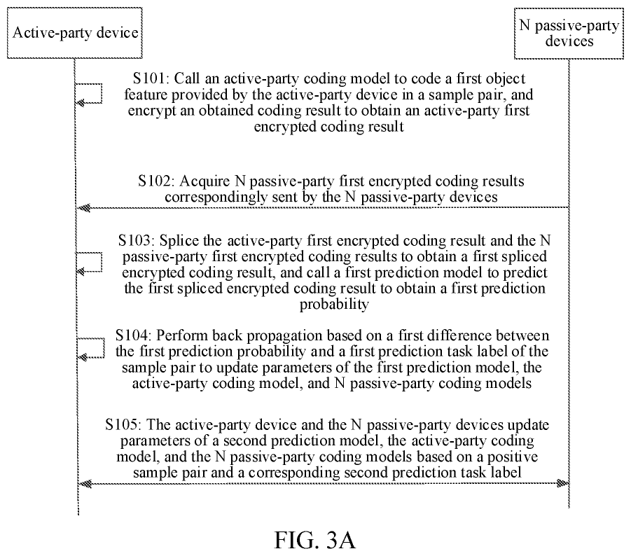

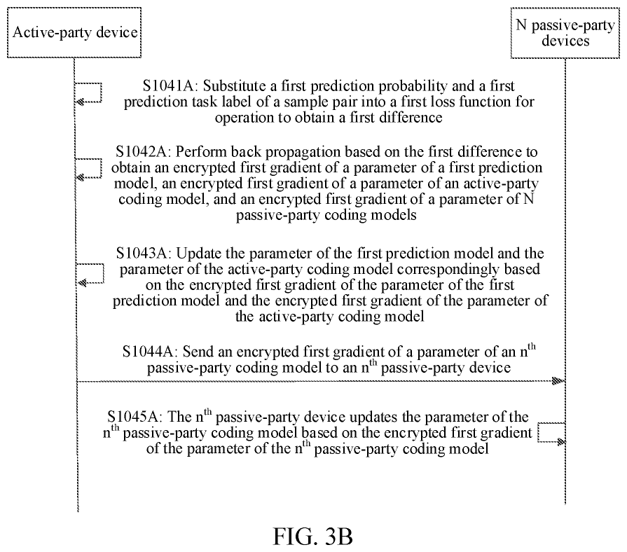

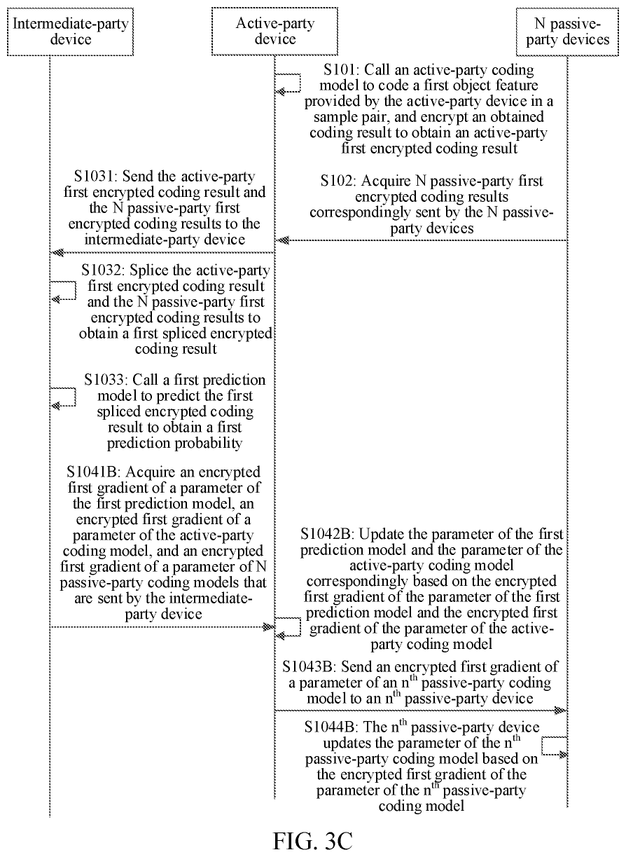

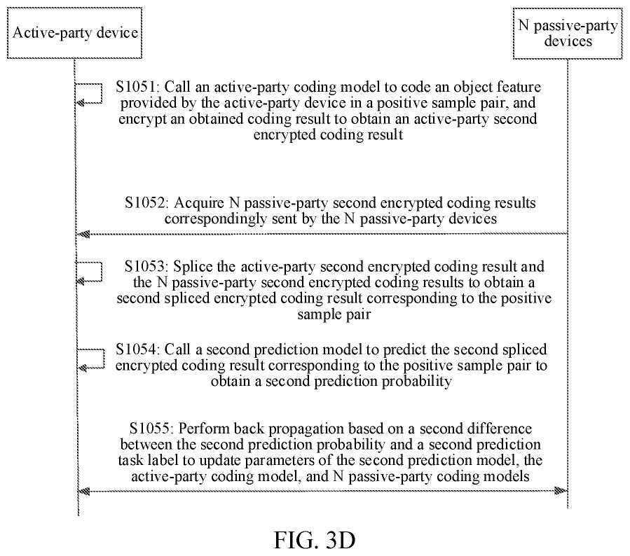

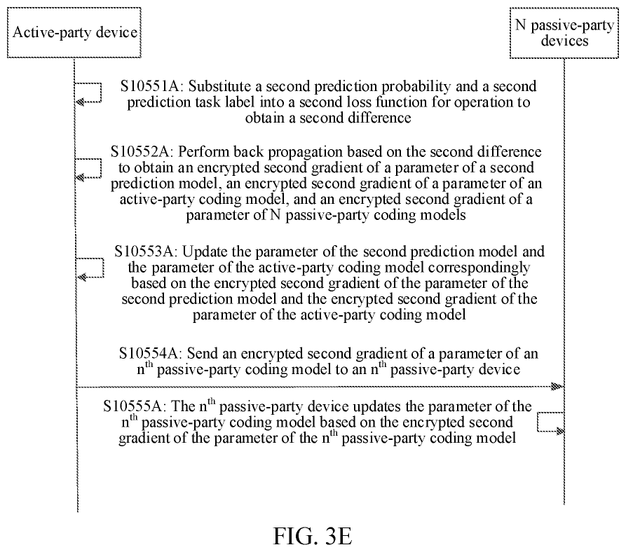

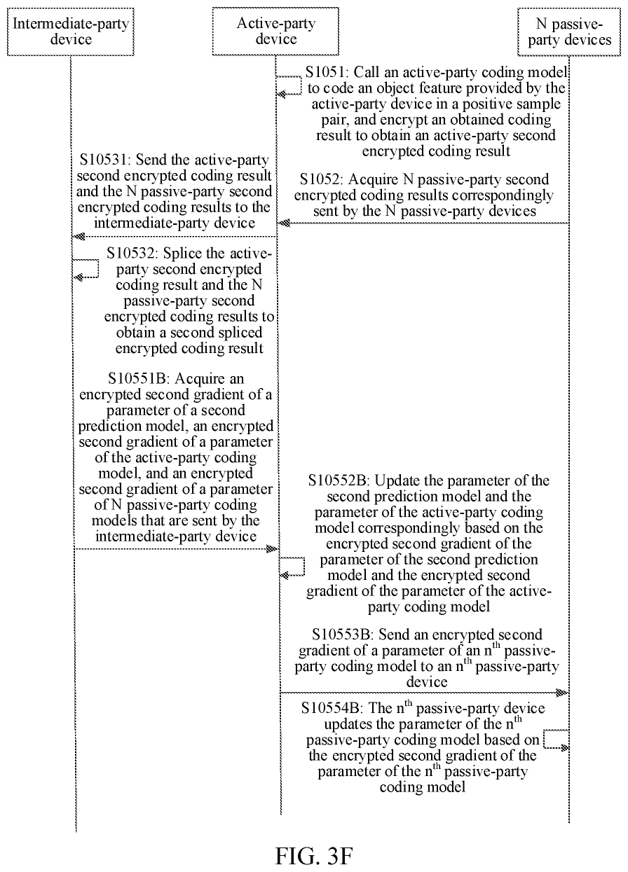

FIG. 3A is a schematic flowchart of steps 101 to 105 in a machine learning model training method according to an embodiment of this application. Descriptions are provided with reference to the steps shown in FIG. 3A.

S101: Call an active-party coding model to code a first object feature provided by an active-party device in a sample pair, and encrypt an obtained coding result to obtain an active-party first encrypted coding result, types of sample pairs including a positive sample pair and a negative sample pair.

For example, the active-party coding model may be a DNN model. After obtaining the active-party first coding result (for example, a hidden-layer vector), the active-party device may encrypt the active-party first coding result by using an encryption algorithm (for example, a homomorphic encryption algorithm) to obtain the active-party first encrypted coding result. The homomorphic encryption algorithm has a characteristic that an output result obtained by operating encrypted data is the same as an output result obtained by operating original data. For example, for a homomorphic encryption algorithm En(a)+En(b)=En(a+b) in which En(a) represents an encryption result obtained by performing homomorphic encryption on data a, En(b) represents an encryption result obtained by performing homomorphic encryption on data b, and En(a+b) represents an encryption result obtained by performing homomorphic encryption on data a+b, a result of adding En(a) to En(b) is the same as En(a+b). For En(a)*En(b)=En(a*b) in which En(a) represents an encryption result obtained by performing homomorphic encryption on data a, En(b) represents an encryption result obtained by performing homomorphic encryption on data b, and En(a*b) represents an encryption result obtained by performing homomorphic encryption on a multiplication result a*b, a result of multiplying En(a) by En(b) is the same as En(a*b).

The coding is implemented by compressing the object feature through a coder (namely, the active-party coding model) in a neural network, to transform the object feature (an analog signal) into the hidden-layer vector (a digital signal) through compression. A model structure of the coder is not limited in the embodiments of this application. For example, the coder may be a convolutional neural network, a recurrent neural network, or a DNN.

In some embodiments, object features in the positive sample pair are from the same object, and a first prediction task label corresponding to the positive sample pair is a probability being 1. Object features in the negative sample pair are from different objects, and a first prediction task label corresponding to the negative sample pair is a probability being 0.

For example, the first object feature provided by the active-party device and a second object feature provided by a passive-party device in the positive sample pair are from the same object. When machine learning model training is performed based on the positive sample pair, the first prediction task label corresponding to the positive sample pair is the probability being 1.

The first object feature provided by the active-party device and a second object feature provided by a passive-party device in the negative sample pair are from different objects. When machine learning model training is performed based on the negative sample pair, the first prediction task label corresponding to the negative sample pair is the probability being 0.

Different labels are used for the positive sample pair and the negative sample pair, so that a trained machine learning model can have a binary classification function. Because the binary classification function is simple and facilitates model generalization, using different labels can improve a generalization capability of the trained machine learning model.

In some embodiments, the first object feature provided by the active-party device in the sample pair is stored in the active-party device, and the second object feature provided by the passive-party device in the sample pair is stored in the passive-party device. The sample pair is processed in batches, and each batch of sample pairs used for training includes K positive sample pairs and L negative sample pairs, where L is an integral multiple of K. The K positive sample pairs include: object features respectively provided by the active-party device and each passive-party device for same K objects, and orders of the K objects in the active-party device and each passive-party device are the same.

For example, the first object feature provided by the active-party device in the sample pair is stored in the active-party device, and the second object feature provided by the passive-party device in the sample pair is stored in the passive-party device. That is, neither the active-party device nor the passive-party device has all the object features in the sample pair. This ensures data security of both the parties. Moreover, the object feature stored in the active-party device and the object feature stored in the passive-party device are not completely the same, and may be completely complementary.

For example, the sample pair is processed in batches. To be specific, the sample pairs used for training are obtained in batches, and one batch of sample pairs is used each time as training data, to iteratively update a parameter of each model, where sample pairs used in different batches are different. Each batch of sample pairs includes the K positive sample pairs and the L negative sample pairs, where L is an integral multiple of K. The K positive sample pairs are determined in the following manner: First, the active-party device and the passive-party device perform object alignment to obtain a cross object between the active-party device and the passive-party device, that is, determine an object owned by both the active-party device and the passive-party device, in other words, align the object. There are many object alignment manners. The following provides exemplary descriptions.

For example, the active-party device and the passive-party device may implement the object alignment by using a private set intersection (PSI) algorithm. The active-party device and the passive-party device exchange encrypted object identifiers (such as phone numbers and certificate numbers of objects) for a plurality of times to find an object intersection between the active-party device and the passive-party device.

For example, the encrypted objects may be aligned by using a public key encryption algorithm (an RSA Algorithm). The active-party device generates a public key pair and a private key pair by using the RSA algorithm and sends the public key pair to the passive-party device. The passive-party device generates one corresponding random number r for each object identifier u owned by the passive-party device, encrypts the random number by using the public key pair to obtain R, hashes each object identifier u to obtain H, multiplies R by H to obtain Y, sends Y to the active-party device, and stores a mapping relationship between Y and the object identifier u to form a mapping table Y-u. The active-party device decrypts Y by using the private key pair to obtain Z. In addition, the active-party device hashes each object identifier u′ owned by the active-party device, to obtain corresponding H′, encrypts H′ by using the private key pair, and then performs hashing to obtain Z′, where u′ and Z′ are in a one-to-one correspondence and form a mapping table Z′-u′. The active-party device sends Z and Z′ together to the passive-party device. The passive-party device performs a concatenation operation on the mapping table Y-u and a mapping table Y-Z to obtain a new mapping table Z-u, divides Z by the random number r, and hashes an obtained result to obtain D. Because there is a one-to-one correspondence between D and Z, there is also a one-to-one correspondence between D and u, and therefore a mapping table D-u exists. The passive-party device performs an intersection operation on D and Z′ to obtain an object identifier set I in an encrypted and hashed state, and finds, in the set I by using the mapping table D-u, an object identifier intersection in a plaintext state to obtain a cross object of the passive-party device. The passive-party device sends the set I to the active-party device. The active-party device finds, in the set I by using a mapping table D′-u′, an object identifier intersection in the plaintext state to obtain a cross object of the active-party device.

After obtaining the cross objects of the active-party device and the passive-party device, K cross objects are selected from the cross objects each time, that is, there are K cross objects in each batch. The active-party device and the passive-party device sort the K cross objects in the same order, and provide the object features in the same order. For example, the K cross objects may be sorted in ascending or descending order of phone numbers of the cross objects or certificate numbers of the cross objects. In this way, the first object feature provided by the active-party device and the second object feature provided by the passive-party device each time are from the same object, to construct one positive sample pair.

For example, K is 4. In a specific batch, the four cross objects between the active-party device and the passive-party device are u1, u2, u3, and u4, and both the active-party device and the passive-party device sort the four cross objects in an order of u1-u2-u3-u4, and provide object features in the same order. When the active-party device provides an object feature of u1, the passive-party device also provides an object feature of u1. In this way, the first object feature provided by the active-party device and the second object feature provided by the passive-party device are both from the object u1, and therefore construct one positive sample pair.

After the alignment, the active-party device and the passive-party device may agree on which cross objects in each batch are to be used for constructing a positive sample pair, and agree on a sorting order of cross objects in each batch. For example, in the foregoing example, the active-party device and the passive-party device agree on using the four cross objects, namely, u1, u2, u3, and u4, in a specific batch to construct a positive sample pair, and agree on a sorting order of the four cross objects as u1-u2-u3-u4.

In the foregoing manner of constructing the positive sample pair, neither the active-party device nor the passive-party device has all the object features in the sample pair. This ensures data privacy of both the active-party device and the passive-party device. The first object feature provided by the active-party device and the second object feature provided by the passive-party device each time in the positive sample pair are from the same cross object, and the cross object has the same order in the active-party device and each passive-party device. Therefore, the second object feature provided by the active-party device and the passive-party device can be accurately acquired based on the cross object and the order of the cross object, thereby improving accuracy of the constructed positive sample pair.

In some embodiments, the L negative sample pairs are obtained in at least one of the following manners: When the active-party device provides an object feature of a first object, each passive-party device provides an object feature of any object other than the first object in the K objects, where the first object is any one of the K objects. When the active-party device provides an object feature of a first object, each passive-party device provides a spliced object feature, where a dimension of the spliced object feature is the same as that of an object feature of the first object and stored in each passive-party device, the spliced object feature is obtained by each passive-party device by splicing a part of object features of each of K−1 objects, and the K−1 objects are objects other than the first object in the K objects.

For example, FIG. 4C is a schematic diagram of construction manners of a negative sample pair according to this embodiment of this application and shows a case in which there is one passive-party device and a value of K is 4. As shown in FIG. 4C, the four cross objects between the active-party device and the passive-party device are an object 1, an object 2, an object 3, and an object 4. An object feature that is of the object 1 and that is provided by the active-party device is represented by X_{B}¹, an object feature that is of the object 1 and that is provided by the passive-party device is represented by X_{A}¹, an object feature that is of the object 4 and that is provided by the active-party device is represented by X_{B}⁴, and an object feature that is of the object 4 and that is provided by the passive-party device is represented by X_{A}⁴.

When the active-party device provides the object feature of the first object, the passive-party device provides the object feature of the object other than the first object in the K objects. In this way, the first object feature provided by the active-party device and the second object feature provided by the passive-party device are from different objects, to construct one negative sample pair.

As illustrated in a construction manner A shown in FIG. 4C, when the active-party device provides the object feature X_{B}¹ of the object 1, the passive-party device provides an object feature of any one of the object 2, the object 3, and the object 4 other than the object 1, for example, provides an object feature X_{A}² of the object 2. In this way, the first object feature provided by the active-party device is from the object 1, while the second object feature provided by the passive-party device is from the object 2. Therefore, (X_{B}¹, X_{A}²) construct one negative sample pair.

For example, when the active-party device provides the object feature of the first object, the passive-party device provides the spliced object feature. The dimension of the spliced object feature is the same as that of the object feature of the first object and stored in the passive-party device, a length of the spliced object feature is the same as that of the object feature of the first object and stored in the passive-party device, and the spliced object feature is obtained by the passive-party device by splicing the part of object features of each object other than the first object. Because the spliced object feature does not include any object feature of the first object, the object feature that is of the first object and that is provided by the active-party device and the spliced object feature provided by the passive-party device are from different objects and construct one negative sample pair.

As illustrated in a construction manner B shown in FIG. 4C, when the active-party device provides the object feature X_{B}¹ of the object 1, the passive-party device provides a spliced object feature X_{A}. A dimension of the spliced object feature X_{A} is the same as that of the object feature X_{A}¹, of the object 1 and stored in the passive-party device, and a length of the spliced object feature X_{A} is also the same as that of X_{A}¹. The spliced object feature X_{A} is obtained by the passive-party device by splicing a part of object features of each of the objects 2, 3, and 4. Because the spliced object feature X_{A} does not include any object feature of the object 1, the object feature that is X_{B}¹ of the object 1 and that is provided by the active-party device and the spliced object feature X_{A} provided by the passive-party device are from different objects. Therefore, (X_{B}¹, X_{A}) construct one negative sample pair.

After the encrypted objects are aligned, the active-party device and the passive-party device may agree on which cross objects in each batch are to be used for constructing the positive sample pair and the negative sample pair, and also agree on a manner of constructing the negative sample pair.

In the foregoing manner of constructing the negative sample pair, neither the active-party device nor the passive-party device has all the object features in the sample pair. This ensures the data privacy of both the active-party device and the passive-party device. Moreover, the object feature that is of the first object and that is provided by the active-party device and the spliced object feature provided by the passive-party device are from different objects, to improve accuracy of the constructed negative sample pair. A plurality of negative sample pairs are constructed based on the object features of the cross objects between the active-party device and the passive-party device, and are used for the machine learning model training, to not only improve utilization of the object features of each party, but also expand a scale of the machine learning model training. This is beneficial to improving the generalization capability of the machine learning model.

S102: Acquire N passive-party first encrypted coding results correspondingly sent by N passive-party devices.

For example, the active-party device receives the passive-party first encrypted coding result sent by each passive-party device. There are N passive-party devices, where N is an integral constant and N≥1. Each passive-party first encrypted coding result is determined based on each passive-party coding model in combination with the second object feature provided by each passive-party device in the sample pair. For example, the passive-party device calls the passive-party coding model to code the second object feature provided by the passive-party device in the sample pair, and encrypts an obtained coding result to obtain the passive-party first encrypted coding result.

In some embodiments, an n^{th} passive-party first encrypted coding result is obtained by an n^{th} passive-party device in the following manner: calling an n^{th} passive-party coding model to code a second object feature provided by the n^{th} passive-party device in the sample pair, and encrypting an obtained n^{th} passive-party first coding result to obtain the n^{th} passive-party first encrypted coding result, where n is an integral variable and 1≤n≤N.

For example, the n^{th} passive-party first encrypted coding result in the N passive-party first encrypted coding results is obtained in the following manner: The n^{th} passive-party device calls the n^{th} passive-party coding model to code the second object feature provided by the n^{th} passive-party device in the sample pair, to obtain the n^{th} passive-party first coding result. The n^{th} passive-party device encrypts the n^{th} passive-party first coding result, for example, by using the homomorphic encryption algorithm, to obtain the n^{th} passive-party first encrypted coding result, where n is an integral variable and 1≤n≤N.

Each passive-party device can accurately determine the passive-party first encrypted coding result corresponding to the passive-party device by calling the corresponding passive-party coding model to code the object feature provided by the corresponding passive party in the sample pair and performing encryption.

S103: Splice the active-party first encrypted coding result and the N passive-party first encrypted coding results to obtain a first spliced encrypted coding result, and call a first prediction model to predict the first spliced encrypted coding result to obtain a first prediction probability, the first prediction probability being a probability indicating that the object features in the sample pair are from the same object.

Refer to FIG. 4A. For example, after receiving the N passive-party first encrypted coding results, the active-party device splices the active-party first encrypted coding result and the N passive-party first encrypted coding results through an aggregation layer to obtain the first spliced encrypted coding result. For example, it is assumed that N is 1, in other words, there is only one passive-party first encrypted coding result, a dimension of the active-party first encrypted coding result (for example, an active-party first encrypted hidden-layer vector) is 16, and a dimension of the passive-party first encrypted coding result (for example, a passive-party first encrypted hidden-layer vector) is 48. After the two results are spliced through the aggregation layer, that is, after the active-party first encrypted hidden-layer vector and the passive-party first encrypted hidden-layer vector are spliced, a dimension of the obtained first spliced encrypted result is 64.

After obtaining the first spliced encrypted coding result, the active-party device calls the first prediction model to predict the first spliced encrypted coding result, to obtain the first prediction probability, the first prediction probability being the probability indicating that the object features in the sample pair are from the same object.

For example, when there is one passive-party device, a formula for calculating the first prediction probability is as follows:

[symbol]

=g(f_{A}(X_{A},θ_{A}),f_{B}(X_{B},θ_{B});ϕ) Formula 1

f_{A} is a mapping function of the passive-party coding model, X_{A} is the second object feature provided by the passive-party device in the sample pair, θ_{A} is a parameter of the passive-party coding model, f_{B} is a mapping function of the active-party coding model, X_{B} is the first object feature provided by the active-party device in the sample pair, and θ_{B} is a parameter of the active-party coding model. g is a mapping function of the first prediction model, and ϕ is a parameter of the first prediction model. [symbol] is a probability that X_{A} and X_{B} are from the same object.

For example, the first prediction model may be a machine learning model such as a linear regression model, a logistic regression model, and a gradient boosting tree model.

S104: Perform back propagation based on a first difference between the first prediction probability and a first prediction task label of the sample pair to update the parameters of the first prediction model, the active-party coding model, and the N passive-party coding models.

For example, the active-party device performs back propagation based on the first difference between the first prediction probability and the first prediction task label of the sample pair to update the parameters of the first prediction model, the active-party coding model, and the N passive-party coding models.

When the sample pair is the positive sample pair, because the first prediction task label corresponding to the positive sample pair is the probability being 1, the active-party device performs back propagation based on a first difference between the first prediction probability and the probability being 1.

When the sample pair is the negative sample pair, because the first prediction task label corresponding to the negative sample pair is the probability being 0, the active-party device performs back propagation based on a first difference between the first prediction probability and the probability being 0.

FIG. 3B is a schematic flowchart of steps 1041A to 1045A in the machine learning model training method according to this embodiment of this application. S104 in FIG. 3A may be implemented through S1041A to S1045A shown in FIG. 3B. S1041A to S1045A are described below with reference to FIG. 3B.

S1041A: Substitute the first prediction probability and the first prediction task label of the sample pair into a first loss function for operation to obtain the first difference.

For example, the active-party device substitutes the first prediction probability and the first prediction task label of the sample pair into the first loss function for calculation to obtain the first difference. For example, when a type of the first loss function is a cross entropy loss function, a calculation formula for the first loss function is as follows:

L1=−[yᵢ·log(yᵢ′)+(1−yᵢ)·log(1−yᵢ′)] Formula 2

yᵢ represents the first prediction task label, yᵢ′ represents the first prediction probability, and L1 represents the first difference.

When the sample pair is the positive sample pair, because the first prediction task label corresponding to the positive sample pair is the probability being 1, a value of yᵢ in Formula 1 is 1.

When the sample pair is the negative sample pair, because the first prediction task label corresponding to the negative sample pair is the probability being 0, a value of yᵢ in Formula 1 is 0.

S1042A: Perform back propagation based on the first difference to obtain an encrypted first gradient of the parameter of the first prediction model, an encrypted first gradient of the parameter of the active-party coding model, and an encrypted first gradient of the parameter of the N passive-party coding models.

For example, after the first difference is calculated, the back propagation is performed based on the first difference, to be specific, the propagation is performed from an output layer to an input layer of the first prediction model, from an output layer to an input layer of the active-party coding model, and from an output layer to an input layer of the passive-party coding model respectively.

In a back propagation process, the active-party device separately calculates the encrypted first gradient of the parameter of the first prediction model, the encrypted first gradient of the parameter of the active-party coding model, and the encrypted first gradient of the parameter of the N passive-party coding models.

S1043A: Update the parameter of the first prediction model and the parameter of the active-party coding model correspondingly based on the encrypted first gradient of the parameter of the first prediction model and the encrypted first gradient of the parameter of the active-party coding model.

For example, after calculating the encrypted first gradient of the parameter of the first prediction model and the encrypted first gradient of the parameter of the active-party coding model, the active-party device separately decrypts the encrypted first gradient of the parameter of the first prediction model and the encrypted first gradient of the parameter of the active-party coding model, updates the parameter of the first prediction model based on an obtained decrypted first gradient of the parameter of the first prediction model, and updates the parameter of the active-party coding model based on an obtained decrypted first gradient of the parameter of the active-party coding model.

S1044A: Send an encrypted first gradient of a parameter of the n^{th} passive-party coding model to the n^{th} passive-party device.

For example, after calculating the encrypted first gradient of the parameter of the N passive-party coding models separately, the active-party device sends the encrypted first gradient of the parameter of the n^{th} passive-party coding model to the n^{th} passive-party device.

S1045A: The n^{th} passive-party device updates the parameter of the n^{th} passive-party coding model based on the encrypted first gradient of the parameter of the n^{th} passive-party coding model.

For example, after receiving the encrypted first gradient of the parameter of the n^{th} passive-party coding model, the n^{th} passive-party device first performs decryption, and then updates the parameter of the n^{th} passive-party coding model based on an obtained decrypted first gradient of the parameter of the n^{th} passive-party coding model.

The gradient of the parameter of each model is obtained through the back propagation performed based on the first difference, and the parameter of each model is updated based on the gradient of the parameter of the corresponding model, so that the parameter of each model can be updated accurately, to help improve efficiency of the machine learning model training.

FIG. 3C is a schematic flowchart of steps 1031 to 1033 and steps 1041B to 1044B in the machine learning model training method according to this embodiment of this application. S103 in FIG. 3A may be implemented through S1031 to S1033 in FIG. 3C, and S104 in FIG. 3A may be implemented through S1041B to S1044B in FIG. 3C. S1031 to S1033 and S1041B to S1044B are described below with reference to FIG. 3C.

S1031: Send the active-party first encrypted coding result and the N passive-party first encrypted coding results to an intermediate-party device.

Refer to FIG. 4B. For example, the active-party device sends the active-party first encrypted coding result and the N passive-party first encrypted coding results to the intermediate-party device.

S1032: The intermediate-party device splices the active-party first encrypted coding result and the N passive-party first encrypted coding results to obtain the first spliced encrypted coding result.

For example, after receiving the active-party first encrypted coding result and the N passive-party first encrypted coding results that are sent by the active-party device, the intermediate-party device splices the active-party first encrypted coding result and the N passive-party first encrypted coding results to obtain the first spliced encrypted coding result.

S1033: The intermediate-party device calls the first prediction model to predict the first spliced encrypted coding result to obtain the first prediction probability.

For example, after obtaining the first spliced encrypted coding result, the intermediate-party device calls the first prediction model to predict the first spliced encrypted coding result, to obtain the first prediction probability.

S1041B: Acquire an encrypted first gradient of the parameter of the first prediction model, an encrypted first gradient of the parameter of the active-party coding model, and an encrypted first gradient of the parameter of the N passive-party coding models that are sent by the intermediate-party device.

For example, the intermediate-party device performs back propagation based on the first difference between the first prediction probability and the first prediction task label of the sample pair, to obtain the encrypted first gradient of the parameter of the first prediction model, the encrypted first gradient of the parameter of the active-party coding model, and the encrypted first gradient of the parameter of the N passive-party coding models, and sends the encrypted first gradient of the parameter of the first prediction model, the encrypted first gradient of the parameter of the active-party coding model, and the encrypted first gradient of the parameter of the N passive-party coding models to the active-party device.

The intermediate-party device substitutes the first prediction probability and the first prediction task label of the sample pair into a first loss function for operation to obtain the first difference, and performs back propagation based on the first difference to obtain the encrypted first gradient of the parameter of the first prediction model, the encrypted first gradient of the parameter of the active-party coding model, and the encrypted first gradient of the parameter of the N passive-party coding models.

S1042B: Update the parameter of the first prediction model and the parameter of the active-party coding model correspondingly based on the encrypted first gradient of the parameter of the first prediction model and the encrypted first gradient of the parameter of the active-party coding model.

For example, after receiving the encrypted first gradient of the parameter of the first prediction model and the encrypted first gradient of the parameter of the active-party coding model, the active-party device separately decrypts the encrypted first gradient of the parameter of the first prediction model and the encrypted first gradient of the parameter of the active-party coding model, updates the parameter of the first prediction model based on an obtained decrypted first gradient of the parameter of the first prediction model, and updates the parameter of the active-party coding model based on an obtained decrypted first gradient of the parameter of the active-party coding model.

S1043B: Send an encrypted first gradient of a parameter of the n^{th} passive-party coding model to the n^{th} passive-party device.

For example, after receiving the encrypted first gradient of the parameter of the N passive-party coding models, the active-party device sends the encrypted first gradient of the parameter of the n^{th} passive-party coding model to the n^{th} passive-party device.

S1044B: The n^{th} passive-party device updates the parameter of the n^{th} passive-party coding model based on the encrypted first gradient of the parameter of the n^{th} passive-party coding model.

For example, after receiving the encrypted first gradient of the parameter of the n^{th} passive-party coding model, the n^{th} passive-party device first performs decryption, and then updates the parameter of the n^{th} passive-party coding model based on the obtained decrypted first gradient of the parameter of the n^{th} passive-party coding model.

The parameter of each model is updated by using the gradient that is of the parameter of the corresponding model and that is calculated by the intermediate-party device, and the active-party and passive-party devices do not need to calculate the gradient of the parameter of the corresponding model. This reduces computational load on the active-party and passive-party devices, thereby improving the efficiency of the machine learning model training, and reducing a hardware requirement on each training participant of the machine learning model.

S105: The active-party device and the N passive-party devices update parameters of a second prediction model, the active-party coding model, and the N passive-party coding models based on the positive sample pair and a corresponding second prediction task label, a prediction task of the second prediction model being different from that of the first prediction model.

For example, after the parameters of the first prediction model, the active-party coding model, and the N passive-party coding models are updated for a plurality of times to make the first prediction model, the active-party coding model, and the N passive-party coding models convergent, the active-party device and the N passive-party devices update the parameters of the second prediction model, the active-party coding model, and the N passive-party coding models based on the positive sample pair and the corresponding second prediction task label. The prediction task of the second prediction model is different from that of the first prediction model.

For example, the prediction task of the second prediction model may be to predict a commodity purchase intention or a game registration probability of an object.

Because the prediction task of the second prediction model is different from that of the first prediction model, the second prediction task label (namely, a target prediction task label) is also different from the first prediction task label. That is, in this embodiment of this application, the first prediction task label that is different from the target prediction task label is introduced to the machine learning model training process, so that a limitation that only the target prediction task label can be used for training in the related art can be eliminated. In this way, the training scale is expanded, the generalization capability of the machine learning model is improved, and an over-fitting problem caused by performing training based on the single target prediction task label is avoided.

For example, the second prediction model may be a machine learning model such as a linear regression model, a logistic regression model, and a gradient boosting tree model.

FIG. 3D is a schematic flowchart of steps 1051 to 1055 in the machine learning model training method according to this embodiment of this application. S105 in FIG. 3A may be implemented through S1051 to S1055 shown in FIG. 3D. S1051 to S1055 are described below with reference to FIG. 3D.

S1051: Call the active-party coding model to code the first object feature provided by the active-party device in the positive sample pair, and encrypt an obtained coding result to obtain an active-party second encrypted coding result.

For example, after obtaining the active-party second coding result, the active-party device may encrypt the active-party second coding result by using the homomorphic encryption algorithm to obtain the active-party second encrypted coding result.

The coding is implemented by compressing the object feature through the coder (namely, the active-party coding model) in the neural network, to transform the object feature (an analog signal) into a hidden-layer vector (a digital signal) through compression. The model structure of the coder is not limited in the embodiments of this application. For example, the coder may be the convolutional neural network, the recurrent neural network, or the DNN.

S1052: Acquire N passive-party second encrypted coding results correspondingly sent by the N passive-party devices.

For example, the active-party device receives the passive-party second encrypted coding result sent by each passive-party device. There are N passive-party devices, where N is an integral constant and N≥1. Each passive-party second encrypted coding result is determined based on each passive-party coding model in combination with the second object feature provided by each passive-party device in the positive sample pair. For example, the passive-party device calls the passive-party coding model to code the second object feature provided by the passive-party device in the positive sample pair, and encrypts an obtained coding result to obtain the passive-party second encrypted coding result.

S1053: Splice the active-party second encrypted coding result and the N passive-party second encrypted coding results to obtain a second spliced encrypted coding result corresponding to the positive sample pair.

For example, after receiving the N passive-party second encrypted coding results, the active-party device splices the active-party second encrypted coding result and the N passive-party second encrypted coding results through the aggregation layer to obtain the second spliced encrypted coding result. For example, it is assumed that N is 1, in other words, there is only one passive-party second encrypted coding result, a dimension of the active-party second encrypted coding result is 16, and a dimension of the passive-party second encrypted coding result is 48. After the two results are spliced through the aggregation layer, a dimension of the obtained second spliced encrypted result is 64.

S1054: Call the second prediction model to predict the second spliced encrypted coding result corresponding to the positive sample pair to obtain a second prediction probability.

After obtaining the second spliced encrypted coding result, the active-party device calls the second prediction model to predict the second spliced encrypted coding result, to obtain the second prediction probability.

S1055: Perform back propagation based on a second difference between the second prediction probability and the second prediction task label to update the parameters of the second prediction model, the active-party coding model, and the N passive-party coding models.

For example, the active-party device performs back propagation based on the second difference between the second prediction probability and the second prediction task label of the positive sample pair to update the parameters of the second prediction model, the active-party coding model, and the N passive-party coding models.

The corresponding second prediction probability is determined based on the positive sample pair, so that the second difference can be accurately calculated based on the accurate second prediction probability. In this way, the parameter of each model can be updated based on the accurate second difference, to improve the efficiency of the machine learning model training.

FIG. 3E is a schematic flowchart of steps 10551A to 10555A in the machine learning model training method according to this embodiment of this application. S1055 in FIG. 3D may be implemented through S10551A to S10555A shown in FIG. 3E. S10551A to S10555A are described below with reference to FIG. 3E.

S10551A: Substitute the second prediction probability and the second prediction task label into a second loss function for operation to obtain the second difference.

For example, the active-party device substitutes the second prediction probability and the second prediction task label into the second loss function for calculation to obtain the second difference. For example, when a type of the second loss function is the cross entropy loss function, a calculation formula for the second loss function is as follows:

L2=−[pᵢ·log(pᵢ′)+(1−pᵢ)·log(1−pᵢ′)] Formula 3

pᵢ represents the second prediction task label, pᵢ′ represents the second prediction probability, and L2 represents the second difference.

S10552A: Perform back propagation based on the second difference to obtain an encrypted second gradient of the parameter of the second prediction model, an encrypted second gradient of the parameter of the active-party coding model, and an encrypted second gradient of the parameter of the N passive-party coding models.

For example, after the second difference is calculated, the back propagation is performed based on the second difference, to be specific, the propagation is performed from an output layer to an input layer of the second prediction model, from the output layer to the input layer of the active-party coding model, and from the output layer to the input layer of the passive-party coding model.

In a back propagation process, the active-party device separately calculates the encrypted second gradient of the parameter of the second prediction model, the encrypted second gradient of the parameter of the active-party coding model, and the encrypted second gradient of the parameter of the N passive-party coding models.

S10553A: Update the parameter of the second prediction model and the parameter of the active-party coding model correspondingly based on the encrypted second gradient of the parameter of the second prediction model and the encrypted second gradient of the parameter of the active-party coding model.

For example, after calculating the encrypted second gradient of the parameter of the second prediction model and the encrypted second gradient of the parameter of the active-party coding model, the active-party device separately decrypts the encrypted second gradient of the parameter of the second prediction model and the encrypted second gradient of the parameter of the active-party coding model, updates the parameter of the second prediction model based on an obtained decrypted second gradient of the parameter of the second prediction model, and updates the parameter of the active-party coding model based on an obtained decrypted second gradient of the parameter of the active-party coding model.

S10554A: Send an encrypted second gradient of the parameter of the n^{th} passive-party coding model to the n^{th} passive-party device.

For example, after calculating the encrypted second gradient of the parameter of the N passive-party coding models separately, the active-party device sends the encrypted second gradient of the parameter of the n^{th} passive-party coding model to the n^{th} passive-party device.

S10555A: The n^{th} passive-party device updates the parameter of the n^{th} passive-party coding model based on the encrypted second gradient of the parameter of the n^{th} passive-party coding model.

For example, after receiving the encrypted second gradient of the parameter of the n^{th} passive-party coding model, the n^{th} passive-party device first performs decryption, and then updates the parameter of the n^{th} passive-party coding model based on an obtained decrypted second gradient of the parameter of the n^{th} passive-party coding model.

The gradient of the parameter of each model is obtained through the back propagation performed based on the second difference, and the parameter of each model is updated based on the gradient of the parameter of the corresponding model, so that the parameter of each model can be updated accurately, to help improve the efficiency of the machine learning model training.

FIG. 3F is a schematic flowchart of steps 10531 and 10532 and steps 10551B to 10554B in the machine learning model training method according to this embodiment of this application. S1053 in FIG. 3D may be implemented through S10531 and S10532 in FIG. 3F, and S1055 in FIG. 3D may be implemented through S10551B to 510554B in FIG. 3F. S10531 and S10532, and S10551B to S10554B are described below with reference to FIG. 3F.

S10531: Send the active-party second encrypted coding result and the N passive-party second encrypted coding results to the intermediate-party device.

For example, the active-party device sends the active-party second encrypted coding result and the N passive-party second encrypted coding results to the intermediate-party device.

S10532: The intermediate-party device splices the active-party second encrypted coding result and the N passive-party second encrypted coding results to obtain the second spliced encrypted coding result.

For example, after receiving the active-party second encrypted coding result and the N passive-party second encrypted coding results that are sent by the active-party device, the intermediate-party device splices the active-party second encrypted coding result and the N passive-party second encrypted coding results to obtain the second spliced encrypted coding result.

S10551B: Acquire an encrypted second gradient of the parameter of the second prediction model, an encrypted second gradient of the parameter of the active-party coding model, and an encrypted second gradient of the parameter of the N passive-party coding models that are sent by the intermediate-party device.

For example, the intermediate-party device calls the second prediction model to predict the obtained second spliced encrypted coding result, to obtain the second prediction probability. Then, the back propagation is performed based on the second difference between the second prediction probability and the second prediction task label of the sample pair, to obtain the encrypted second gradient of the parameter of the second prediction model, the encrypted second gradient of the parameter of the active-party coding model, and the encrypted second gradient of the parameter of the N passive-party coding models, and the encrypted second gradients are sent to the active-party device.

S10552B: Update the parameter of the second prediction model and the parameter of the active-party coding model correspondingly based on the encrypted second gradient of the parameter of the second prediction model and the encrypted second gradient of the parameter of the active-party coding model.

For example, after receiving the encrypted second gradient of the parameter of the second prediction model and the encrypted second gradient of the parameter of the active-party coding model, the active-party device separately decrypts the encrypted second gradient of the parameter of the second prediction model and the encrypted second gradient of the parameter of the active-party coding model, updates the parameter of the second prediction model based on an obtained decrypted second gradient of the parameter of the second prediction model, and updates the parameter of the active-party coding model based on an obtained decrypted second gradient of the parameter of the active-party coding model.

S10553B: Send an encrypted second gradient of the parameter of the n^{th} passive-party coding model to the n^{th} passive-party device.

For example, after receiving the encrypted second gradient of the parameter of the N passive-party coding models, the active-party device sends the encrypted second gradient of the parameter of the n^{th} passive-party coding model to the n^{th} passive-party device.

S10554B: The n^{th} passive-party device updates the parameter of the n^{th} passive-party coding model based on the encrypted second gradient of the parameter of the n^{th} passive-party coding model.

For example, after receiving the encrypted second gradient of the parameter of the n^{th} passive-party coding model, the n^{th} passive-party device first performs decryption, and then updates the parameter of the n^{th} passive-party coding model based on an obtained decrypted second gradient of the parameter of the n^{th} passive-party coding model.

The gradient of the parameter of each model is calculated by the intermediate-party device, the parameter of each model is updated based on the gradient that is of the parameter of the corresponding model and that is calculated by the intermediate-party device, and the active-party and passive-party devices do not need to calculate the gradient of the parameter of the corresponding model. This reduces computational load on the active-party and passive-party devices, thereby improving the efficiency of the machine learning model training, and reducing the hardware requirement on each training participant of the machine learning model.

In this embodiment of this application, the first prediction model is trained by using the second object feature provided by the active-party device and the passive-party device in the sample pair. Because the first prediction probability obtained through prediction using the first prediction model is the probability indicating that the object features in the sample pair are from the same object, the first prediction model can make representation of object features of the same object in the active-party device and the passive-party device approximate to each other. Because the prediction task of the first prediction model is different from that of the second prediction model, the first prediction task label is also different from the second prediction task label. The first prediction task label reflects whether a plurality of object features are from the same object, and imposes no restriction on the object features used for training, that is, quantities of positive sample pairs and negative sample pairs used for training are very large. Therefore, introducing the first prediction task label that is different from the target prediction task label can expand the training scale and enable the trained machine learning model to have the good generalization capability, to improve accuracy of a prediction result of the machine learning model.

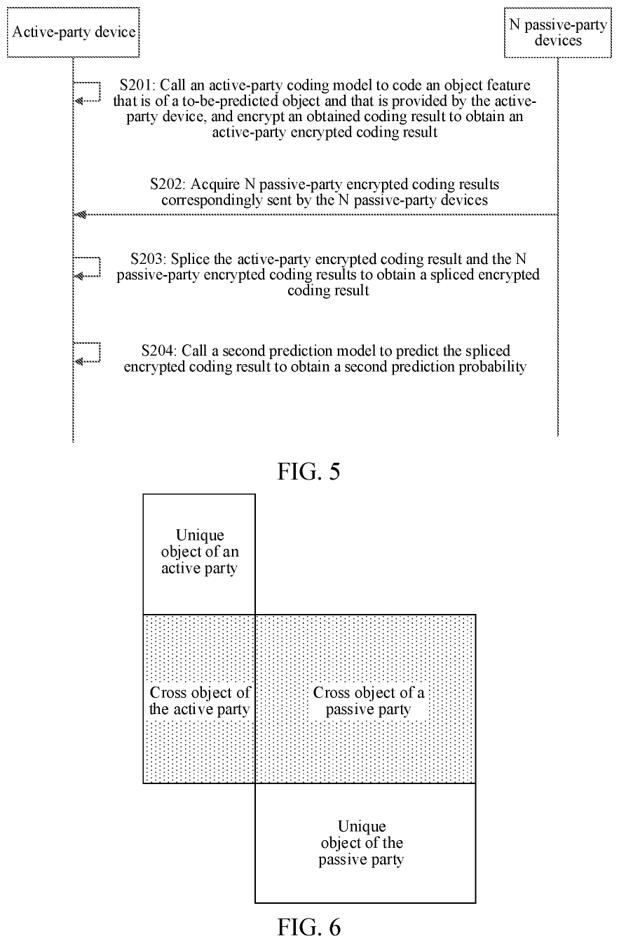

FIG. 5 shows a machine learning model-based prediction method according to an embodiment of this application. The method is applied to an active-party device. The following provides descriptions with reference to steps shown in FIG. 5.

S201: Call an active-party coding model to code an object feature that is of a target object and that is provided by the active-party device, and encrypt an obtained coding result to obtain an active-party encrypted coding result.

For example, the active-party device calls the active-party coding model to code the object feature of the target object, and encrypts the obtained coding result to obtain the active-party encrypted coding result.

The coding is implemented by compressing the object feature through a coder (namely, the active-party coding model) in a neural network, to transform the object feature (an analog signal) into a hidden-layer vector (a digital signal) through compression. A model structure of the coder is not limited in the embodiments of this application. For example, the coder may be a convolutional neural network, a recurrent neural network, or a DNN.

S202: Acquire N passive-party encrypted coding results correspondingly sent by N passive-party devices.

For example, the active-party device receives the passive-party encrypted coding result sent by each passive-party device. There are N passive-party devices, where N is an integral constant and N≥1. Each passive-party encrypted coding result is determined based on each passive-party coding model in combination with an object feature that is of the target object and that is provided by each passive-party device. For example, the passive-party device calls the passive-party coding model to code a second object feature that is of the target object and that is provided by the passive-party device, and encrypts an obtained coding result to obtain the passive-party encrypted coding result.

In some embodiments, an n^{th} passive-party encrypted coding result is sent by an n^{th} passive-party device in response to a prediction request of the active-party device, and the prediction request of the active-party device carries an object identifier of the target object. The n^{th} passive-party encrypted coding result is obtained in the following manner: calling an n^{th} passive-party coding model to code the object feature that is of the target object and that is provided by the n^{th} passive-party device, and encrypting an obtained n^{th} passive-party coding result to obtain the n^{th} passive-party encrypted coding result.

For example, the n^{th} passive-party encrypted coding result is obtained by the n^{th} passive-party device in an offline state in the following manner before the n^{th} passive-party device receives the prediction request of the active-party device: calling the n^{th} passive-party coding model to code the object feature that is of the target object and that is provided by the n^{th} passive-party device, and encrypting the obtained n^{th} passive-party coding result to obtain the n^{th} passive-party encrypted coding result. The offline state refers to a state in which the passive-party device has no network connection.

After receiving the prediction request sent by the active-party device, the n^{th} passive-party device obtains, based on the object identifier that is of the target object and that is carried in the prediction request, the passive-party encrypted coding result corresponding to the target object from passive-party encrypted coding results that correspond to a plurality of objects and that are stored in the n^{th} passive-party device, and sends the passive-party encrypted coding result to the active-party device.

The passive-party device obtains, in advance in the offline state, the passive-party encrypted coding results corresponding to the plurality of objects. After receiving the prediction request sent by the active-party device, the passive-party device can quickly send the passive-party encrypted coding result corresponding to the target object to the active-party device. This reduces time for the passive-party device to obtain the passive-party encrypted coding result corresponding to the target object online, thereby improving efficiency of determining a second prediction probability.

For example, the n^{th} passive-party encrypted coding result is obtained by the n^{th} passive-party device in an online state in the following manner after the n^{th} passive-party device receives the prediction request of the active-party device: calling the n^{th} passive-party coding model to code the object feature that is of the target object and that is provided by the n^{th} passive-party device, and encrypting the obtained n^{th} passive-party coding result to obtain the n^{th} passive-party encrypted coding result. The online state refers to a state in which the passive-party device has a network connection.

After receiving the prediction request sent by the active-party device, the n^{th} passive-party device calls the n′ passive-party coding model based on the object identifier that is of the target object and that is carried in the prediction request, to determine the n^{th} passive-party encrypted coding result, and sends the n^{th} passive-party encrypted coding result to the active-party device.

The passive-party device obtains the passive-party encrypted coding result in real time in the online state, to avoid storing a large quantity of passive-party encrypted coding results in the passive-party device, thereby saving storage space of the passive-party device.

S203: Splice the active-party encrypted coding result and the N passive-party encrypted coding results to obtain a spliced encrypted coding result.

For example, after receiving the N passive-party encrypted coding results, the active-party device splices the active-party encrypted coding result and the N passive-party encrypted coding results through an aggregation layer to obtain the spliced encrypted coding result.

S204: Call a second prediction model to predict the spliced encrypted coding result to obtain the second prediction probability.

For example, the active-party device calls the second prediction model to predict the spliced encrypted coding result, to obtain the second prediction probability.

For example, the second prediction probability may represent a commodity purchase intention of the object. A higher second prediction probability indicates a stronger commodity purchase intention of the object. A lower second prediction probability indicates a weaker commodity purchase intention of the object. In this scenario, the active-party device may be an electronic device deployed in an e-commerce institution, and the passive-party device may be an electronic device deployed in a banking institution. A first object feature provided by the active-party device may be a commodity purchase feature of the object, for example, a purchase frequency feature and a purchase preference feature, and a second object feature provided by the passive-party device may be an age feature, a gender feature, and the like of the object.

For example, the second prediction probability may alternatively represent a game registration probability of the object. A higher second prediction probability indicates a higher game registration probability of the object. A lower second prediction probability indicates a lower game registration probability of the object. In this scenario, the active-party device is an electronic device deployed in a game enterprise, and the passive-party device is an electronic device deployed in an advertising enterprise. A first object feature provided by the active-party device may be a payment behavior feature of the object in a specific game, and a second object feature provided by the passive-party device may be an interest feature of the object to a specific advertisement.

The active-party coding model, the N passive-party coding models, and the second prediction model are trained according to any machine learning model training method shown in FIG. 3A to FIG. 3F.

Performing prediction through the trained active-party coding model, N passive-party coding models, and second prediction model can obtain an accurate prediction result.

An exemplary application of this embodiment of this application in an actual machine learning model-based prediction scenario is described below by using an example in which there is one passive-party device, the active-party device is the electronic device deployed in the game enterprise, and the passive-party device is the electronic device deployed in the advertising enterprise or an electronic device deployed in an enterprise providing a social media service.

This embodiment of this application may have the following application scenario: calling the active-party coding model to code the payment behavior feature that is of the target object in the specific game and that is provided by the active-party device, and encrypting an obtained coding result to obtain an active-party encrypted coding result; acquiring a passive-party encrypted coding result sent by the passive-party device, where the passive-party coding result is obtained by calling the passive-party coding model to code the interest feature that is of the target object to the specific advertisement and that is provided by the passive-party device and encrypting an obtained coding result; splicing the active-party encrypted coding result and the passive-party encrypted coding result to obtain a spliced encrypted coding result; and calling the second prediction model to predict the spliced encrypted coding result, to obtain a probability that the target object registers with the specific game after clicking the specific advertisement.

For example, the passive-party coding result is obtained by calling the passive-party coding model to code a browsing behavior feature that is of the target object to specific social media content and that is provided by the passive-party device and encrypting an obtained coding result. In this case, the active-party encrypted coding result and the passive-party encrypted coding result are spliced to obtain a spliced encrypted coding result. The second prediction model is called to predict the spliced encrypted coding result, to obtain a probability that the target object registers with the specific game after browsing the specific social media content.

This embodiment of this application may also be applied to a target recognition scenario, and descriptions are provided by using an example in which the active-party device is an electronic device for video playing and the passive-party device is an electronic device providing a social media service:

calling the active-party coding model to code a browsing behavior feature that is of the target object in a specific video and that is provided by the active-party device, and encrypting an obtained coding result to obtain an active-party encrypted coding result; acquiring a passive-party encrypted coding result sent by the passive-party device, where the passive-party coding result is obtained by calling the passive-party coding model to code an interaction feature that is of the target object with a specific target (namely, image data obtained by performing target recognition on a specific image) and that is provided by the passive-party device and encrypting an obtained coding result; splicing the active-party encrypted coding result and the passive-party encrypted coding result to obtain a spliced encrypted coding result; and calling the second prediction model to predict the spliced encrypted coding result, to obtain a probability that the target object watches the specific video after clicking the specific image.

Because the passive-party device codes and encrypts the interaction feature with the specific target, in a process of data exchange between the active-party device and the passive-party device, on the premise of ensuring data security, both the parties can train a high-precision second prediction model by using a large quantity of samples, to improve prediction accuracy of the second prediction model.

In the embodiments of this application, the positive and negative sample pairs are constructed based on the object features that are of the cross objects and that are provided by the active and passive parties, and a VFL model is pre-trained based on the positive and negative sample pairs, to make representation of object features of the same object approximate to each other. In a fine-tuning training phase, the pre-trained active-party coding model, the pre-trained passive-party coding model, and the initialized second prediction model are used for further training, and training data used for the training are the positive sample pair. The VFL model trained in this manner has a more accurate prediction effect.

For example, before training of the VFL model, the active-party device and the passive-party device first align encrypted objects to determine the cross object between the active-party device and the passive-party device. For example, the encrypted objects of the active-party device and the passive-party device may be aligned by using the PSI algorithm.

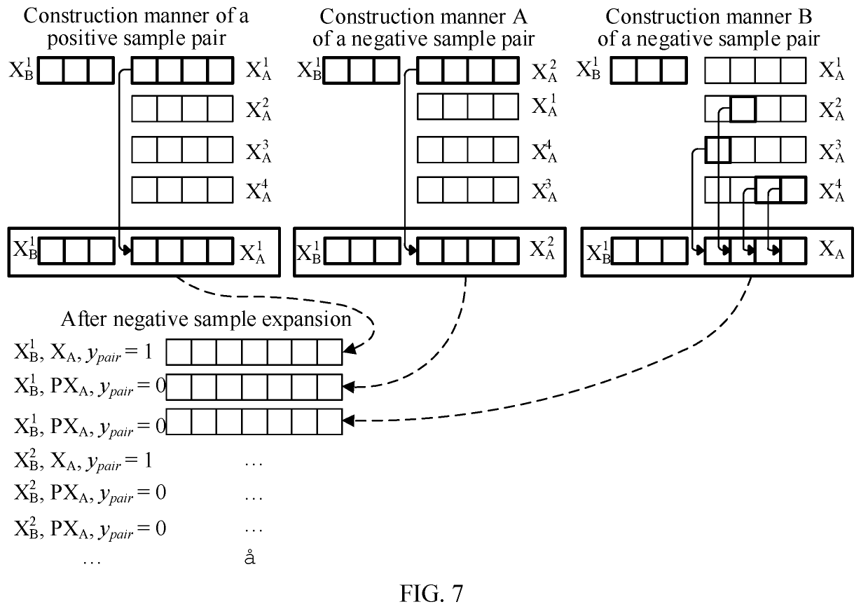

FIG. 6 is a schematic diagram of object cross between an active-party device and a passive-party device according to an embodiment of this application. After encryption and alignment, there are some cross objects between the active-party device and the passive-party device, where the cross object represents an object that belongs to both the active-party device and the passive-party device. Each of the active-party device and the passive-party device has some unique objects.

For example, the active-party device includes objects (u1, u2, u3, u4), and the passive-party device includes objects (u1, u2, u5). In this case, the cross objects between the active-party device and the passive-party device are (u1, u2), the unique objects of the active-party device are (u3, u4), and the unique object of the passive-party device is u5.

In a VFL model training process, the active-party device provides label data and training data. For example, when the active-party device is an electronic device deployed in a game enterprise, the label data provided by the active party may be a game registration probability label (namely, an actual game registration probability of the object), and the training data includes payment behavior features of the object in various games.

The passive party provides training data. For example, when the passive-party device is an electronic device deployed in an advertising enterprise, the training data includes interest features of the object to mass advertisements. When the passive-party device is an electronic device deployed in an enterprise providing a social media service, the training data is a behavior feature that is of the object and that is extracted from social media content.

To enable a VFL model to learn, in training data with no label, correlation between second object features provided by the active-party device and the passive-party device, a comparative pairing-based discrimination task is designed in a pre-training phase. The comparative pairing-based discrimination task is to enable the trained VFL model to have a binary classification function, to be specific, to distinguish whether the second object features provided by the active-party device and the passive-party device are from the same object.

To enable the VFL model to implement the binary classification function, a pairing label yₚₐᵢᵣ (namely, the foregoing first prediction task label) is introduced, and a value of yₚₐᵢᵣ is set as follows:

$${y}_{p a i r} = \{ \begin{matrix}1 , {X}_{A} , {X}_{B} that are from different objects \\ 0 , {X}_{A} , {X}_{B} that are from different objects\end{matrix} \qquad Formula 4$$

X_{A} represents the second object feature provided by the passive-party device, and X_{B} is the first object feature provided by the active-party device. When X_{A} and X_{B} are from the same object, the value of yₚₐᵢᵣ is 1. When X_{A} and X_{B} are from different objects, the value of yₚₐᵢᵣ is 0.

For example, the first object feature provided by the active-party device in a sample pair is stored in the active-party device, and the second object feature provided by the passive-party device in the sample pair is stored in the passive-party device. Each batch of sample pairs for training includes K positive sample pairs and L negative sample pairs, where L is an integral multiple of K. The positive sample pair includes an object feature in the active-party device and an object feature in the passive-party device that are from the same object, and may be represented by (X_{A}, X_{B}). The negative sample pair includes an object feature in the active-party device and an object feature in the passive-party device that are from different objects, and may be represented by (PX_{A}, X_{B}). X_{A} and X_{B} respectively represent object feature matrices provided by the passive-party device and the active-party device for the same batch, and P represents a sequence scrambled matrix.

For example, the positive sample pair is constructed as follows: It is assumed that there are K cross objects between the active-party device and the passive-party device in the same batch, and the active-party device and the passive-party device sort the K cross objects in the same order, and sequentially provide object features in the same order. In this case, the first object feature and the second object feature respectively provided by the active-party device and the passive-party device each time are from the same object, to construct one positive sample pair.

For example, there are four cross objects, namely, u1, u2, u3, and u4, between the active-party device and the passive-party device in the same batch, and both the active-party device and the passive-party device sort the four objects in an order of u1-u2-u3-u4, and sequentially provide object features in the order. For example, the active-party device provides an object feature of u1, and the passive-party device also provides an object feature of u1. In this way, the first object feature provided by the active-party device and the second object feature provided by the passive-party device are both from the object u1. Therefore, the first object feature provided by the active-party device and the second object feature provided by the passive-party device construct one positive sample pair.

For example, the negative sample pair is constructed as follows: If the active-party device and the passive-party device sort the K cross objects in different orders, and sequentially provide object features in the corresponding orders. In this way, the first object feature and the second object feature respectively provided by the active-party device and the passive-party device each time are from different objects, to construct one negative sample pair.

Still with reference to the foregoing example, if the cross-objects in the active-party device are sorted in an order of u1-u2-u3-u4, and the cross-objects in the passive-party device are sorted in an order of u4-u1-u2-u3, when the active-party device provides an object feature of u1, the passive-party device provides an object feature of u4. In this way, the first object feature provided by the active-party device and the second object feature provided by the passive-party device are from different objects, and therefore construct one negative sample pair.

For example, the negative sample pair may alternatively be constructed in the following manner: When the active-party device provides an object feature of a first object, the passive-party device provides a spliced object feature. A dimension of the spliced object feature is the same as that of the object feature of the first object and stored in the passive-party device. The spliced object feature is obtained by the passive-party device by splicing a part of object features of each of K−1 objects, and the K−1 objects are objects other than the first object in the K objects. Because the spliced object feature does not include the object feature of the first object, the object feature that is of the first object and that is provided by the active-party device and the spliced object feature provided by the passive-party device are from different objects and construct one negative sample pair.

Still with reference to the foregoing example, if cross objects between the active-party device and the passive-party device in the same batch are u1, u2, u3, and u4, when the active-party device provides an object feature of the object u1, the passive-party device selects a part of object features from each of the objects u2, u3, and u4, and splices the object features into an object feature of the same dimension and the same length as the object feature that is of the object u1 and that is in the passive-party device. In this way, the object feature that is of the object u1 and that is provided by the active-party device and the spliced object feature provided by the passive-party device construct one negative sample pair.

FIG. 7 is a schematic diagram of construction manners of a positive sample pair and a negative sample pair according to an embodiment of this application. For example, X_{A} represents a second object feature provided by a passive-party device, X_{B} represents a first object feature provided by an active-party device, and cross objects between the passive-party device and the active-party device are an object 1, an object 2, an object 3, and an object 4.

As in the construction manner of the positive sample pair shown in FIG. 7, both the passive-party device and the active-party device sort the cross objects in an order of object 1-object 2-object 3-object 4, and sequentially provide object features in the order. In this way, the first object feature and the second object feature respectively provided by the active-party device and the passive-party device each time construct one positive sample pair. For example, the first object feature X_{B}¹ provided by the active-party device and the second object feature X_{A}¹ provided by the passive-party device are both from the object 1. Therefore, (X_{B}¹, X_{A}¹) construct one positive sample pair. Similarly, (X_{B}⁴, X_{A}⁴) also construct one positive sample pair. A pairing label yₚₐᵢᵣ corresponding to the positive sample pair is 1.

As in a construction manner A of the negative sample pair shown in FIG. 7, when the active-party device sorts the cross objects in an order of object 1-object 2-object 3-object 4, the passive-party device sorts the cross objects in an order of object 2-object 1-object 4-object 3, and the active-party device and the passive-party device sequentially provide object features in the corresponding orders. In this way, the first object feature and the second object feature respectively provided by the active-party device and the passive-party device each time construct one negative sample pair. For example, the first object feature provided by the active-party device is X_{B}¹, and the second object feature provided by the passive-party device is X_{A}². In this way, the first object feature provided by the active-party device is from the object 1, and the second object feature provided by the passive-party device is from the object 2. Therefore, (X_{B}¹, X_{A}²) construct one negative sample pair. Similarly, (X_{B}⁴, X_{A}³) also construct one negative sample pair. A pairing label yₚₐᵢᵣ corresponding to the negative sample pair is 0.

As in a construction manner B of the negative sample pair shown in FIG. 7, when the active-party device provides an object feature X_{B}¹ of the object 1, the passive-party device provides a spliced object feature X_{A}. A dimension of the spliced object feature X_{A} is the same as that of an object feature X_{A} of the object 1 and stored in the passive-party device. The spliced object feature X_{A} is obtained by the passive-party device by splicing a part of object features of each of the objects 2, 3, and 4. Because the spliced object feature X_{A} does not include the object feature of the object 1, the object feature that is of the object 1 and that is provided by the active-party device and the spliced object feature X_{A} provided by the passive-party device are from different objects. Therefore, (X_{B}¹, X_{A}) constructs one negative sample pair. A pairing label yₚₐᵢᵣ corresponding to the negative sample pair is 0.

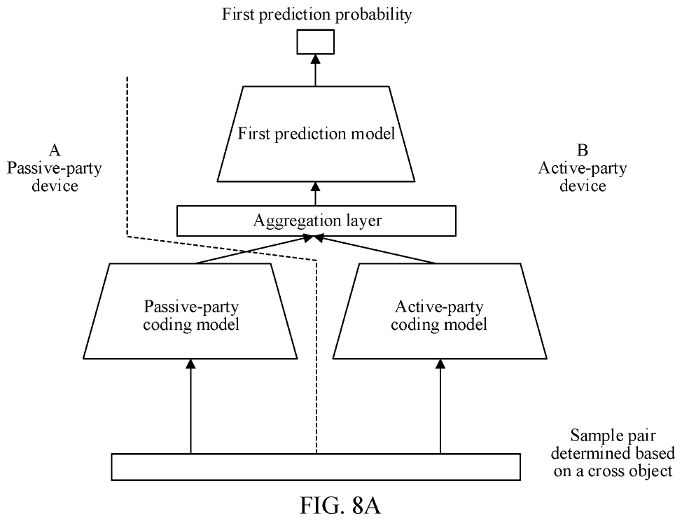

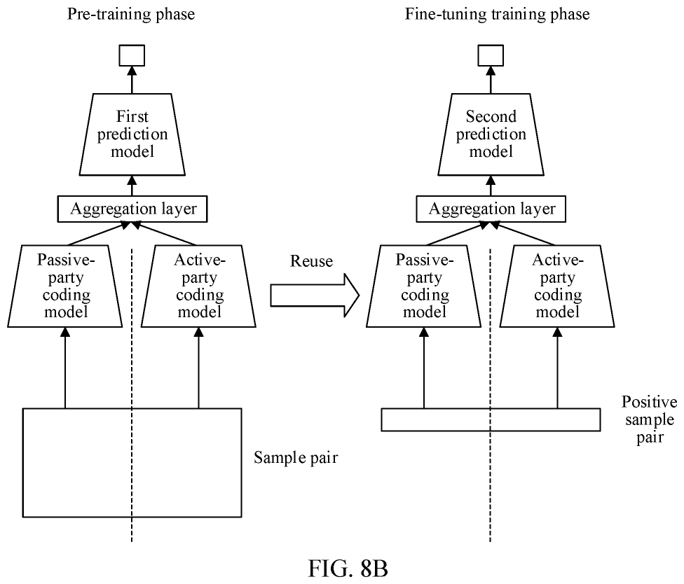

FIG. 8A is a schematic structural diagram of a machine learning model in a pre-training phase according to an embodiment of this application. In the pre-training phase, an active-party coding model is called to code a first object feature provided by an active-party device in a sample pair, to obtain a coding result, and the coding result is encrypted, for example, by using a homomorphic encryption algorithm, to obtain an active-party first encrypted coding result. Types of sample pairs include a positive sample pair and a negative sample pair.

A passive-party first encrypted coding result sent by a passive-party device is received, where the passive-party first encrypted coding result is obtained by the passive-party device in the following manner: calling a passive-party coding model to code an object feature provided by the passive party in the sample pair, to obtain a coding result; encrypting the coding result, for example, by using the homomorphic encryption algorithm, to obtain the passive-party first encrypted coding result;

splicing the active-party first encrypted coding result and the passive-party first encrypted coding result through an aggregation layer of the active-party device to obtain a first spliced encrypted coding result; and calling a first prediction model to predict the first spliced encrypted coding result, to obtain a first prediction probability representing that the object features in the sample pair are from the same object. For example, a calculation formula for the first prediction probability is as follows:

[symbol]

=g(f_{A}(X_{A},θ_{A}),f_{B}(X_{B},θ_{B});ϕ) Formula 5

f_{A} is a mapping function of the passive-party coding model, X_{A} is a second object feature provided by the passive-party device in the sample pair, and θ_{A} is a parameter of the passive-party coding model. f_{B} is a mapping function of the active-party coding model, X_{B} is the first object feature provided by the active-party device in the sample pair, and θ_{B} is a parameter of the active-party coding model. g is a mapping function of the first prediction model, and ϕ is a parameter of the first prediction model. [symbol] is the probability that X_{A} and X_{B} are from the same object.

For example, each model is trained in the pre-training phase by using a standard batch gradient descent method. For example, back propagation is performed based on a first difference between the first prediction probability and a pairing label of the sample pair to update the parameters of the first prediction model, the active-party coding model, and the passive-party coding model. For example, the first prediction probability and the pairing label of the sample pair are substituted into a first loss function to calculate the first difference, and the back propagation is performed based on the first difference to obtain an encrypted first gradient of the parameter of the first prediction model, an encrypted first gradient of the parameter of the active-party coding model, and an encrypted first gradient of the parameter of the passive-party coding model. The active-party device decrypts the encrypted first gradient of the parameter of the first prediction model and the encrypted first gradient of the parameter of the active-party coding model, updates the parameter of the first prediction model based on a decrypted first gradient of the parameter of the first prediction model, and updates the parameter of the active-party coding model based on a decrypted first gradient of the parameter of the active-party coding model. For example, an adaptive moment estimation (ADAM) optimizer is used for minimizing the first loss function, where a type of the first loss function may be a cross entropy loss function. During the back propagation, a learning rate of each model may be set to 1e-4. In a pre-training process, a least squares L2 regularization term is added to a weight of each model to avoid over-fitting. For example, a coefficient of the L2 regularization term may be set to 1e-5.

For example, X_{A} and X_{B} in the sample pair used for training are from the same object. The first prediction model is called based on the first spliced encrypted coding result corresponding to the sample pair, to obtain a first prediction probability as 0.6. However, actually, the sample pair is a positive sample pair, and a corresponding pairing label is a probability being 1. In this case, 0.6 and 1 are substituted into the first loss function to calculate the first difference, and the back propagation is performed based on the first difference to obtain the encrypted first gradient of the parameter of each model.

After obtaining the encrypted first gradient of the parameter of the passive-party coding model, the active-party device sends the encrypted first gradient of the parameter of the passive-party coding model to the passive-party device. The passive-party device decrypts the encrypted first gradient, and updates the parameter of the passive-party coding model based on a decrypted first gradient. In this way, the parameter of each model is updated once, and the foregoing steps are repeated until a maximum quantity of training times is reached or the first difference is less than a specified threshold.

In the pre-training phase, there are a large quantity of cross objects between the active-party device and the passive-party device, and the pairing tag used in the pre-training phase is not label data actually generated by the active-party device.

FIG. 8B is a schematic structural diagram of machine learning models in a pre-training phase and a fine-tuning phase according to an embodiment of this application. After the pre-training phase ends, the fine-tuning training phase starts. An active-party coding model and a passive-party coding model that are used in the fine-tuning training phase are an active-party coding model and a passive-party coding model that are obtained after the pre-training phase ends, and a second prediction model is a re-initialized model.

In the fine-tuning training phase, for example, the active-party coding model is called to code a first object feature provided by an active-party device in a positive sample pair, and an obtained coding result is encrypted, for example, by using a homomorphic encryption algorithm, to obtain an active-party second encrypted coding result.

A passive-party second encrypted coding result sent by a passive-party device is received, where the passive-party second encrypted coding result is obtained by the passive-party device in the following manner: calling the passive-party coding model to code an object feature provided by the passive party in the positive sample pair, to obtain a coding result; and encrypting the coding result, for example, by using the homomorphic encryption algorithm, to obtain the passive-party second encrypted coding result.

The active-party second encrypted coding result and the passive-party second encrypted coding result are spliced through an aggregation layer of the active-party device to obtain a second spliced encrypted coding result corresponding to the positive sample pair. The second prediction model is called to predict the second spliced encrypted coding result corresponding to the positive sample pair to obtain a second prediction probability.

For example, each model is trained in the fine-tuning training phase by using a standard batch gradient descent method. For example, back propagation is performed based on a second difference between the second prediction probability and a second prediction task label to update parameters of the second prediction model, the active-party coding model, and the passive-party coding model. For example, the second prediction probability and the second prediction task label of the positive sample pair are substituted into a second loss function to calculate the second difference, and the back propagation is performed based on the second difference to obtain an encrypted second gradient of the parameter of the second prediction model, an encrypted second gradient of the parameter of the active-party coding model, and an encrypted second gradient of the parameter of the passive-party coding model. The active-party device separately decrypts the encrypted second gradient of the parameter of the second prediction model and the encrypted second gradient of the parameter of the active-party coding model, updates the parameter of the second prediction model based on a decrypted second gradient of the parameter of the second prediction model, and updates the parameter of the active-party coding model based on a decrypted second gradient of the parameter of the active-party coding model. For example, an ADAM optimizer may be used for minimizing the second loss function, where a type of the second loss function may be a cross entropy loss function. During the back propagation, learning rates of the passive-party coding model and the active-party coding model are less than a learning rate of the second prediction model. For example, the learning rates of the passive-party coding model and the active-party coding model may be set to 1e-3, and the learning rate of the second prediction model is 1e-2. In a fine-tuning training process, an L2 regularization term is added to a weight of each model to avoid over-fitting. For example, a coefficient of the L2 regularization term may be set to 1e-5.

For example, X_{A} and X_{B} in the positive sample pair for training are from the same object 1, and the second prediction model is called based on the second spliced encrypted coding result corresponding to the positive sample pair, to obtain a second prediction probability as 0.3. Assuming that the second prediction probability is a game registration probability of an object corresponding to a second object feature provided by the active-party device and the passive-party device, and a second prediction task probability is an actual game registration probability of the object, the game registration probability that is of the object 1 and that is predicted by using the second prediction model is 0.3, and the actual game registration probability of the object 1 is 0.6. In this case, 0.3 and 0.6 are substituted into the second loss function to calculate the second difference, and the back propagation is performed based on the second difference to obtain the encrypted second gradient of the parameter of each model.

After obtaining the encrypted second gradient of the parameter of the passive-party coding model, the active-party device sends the encrypted second gradient of the parameter of the passive-party coding model to the passive-party device. The passive-party device decrypts the encrypted second gradient, and updates the parameter of the passive-party coding model based on a decrypted second gradient. In this way, the parameter of each model is updated once, and the foregoing steps are repeated until a maximum quantity of training times is reached or the second difference is less than a specified threshold.

A small amount of training data, namely, a small quantity of positive sample pairs, are used in the fine-tuning training phase, and the label used in the fine-tuning training phase is label data actually generated by the active-party device.

After the fine-tuning training phase ends, a machine learning model obtained after the fine-tuning training phase may be used for prediction. For example, when a second prediction probability of an object 2 needs to be obtained, the active-party coding model is first called to code an object feature that is of the object 2 and that is provided by the active-party device, and a coding result is encrypted, for example, by using the homomorphic encryption algorithm, to obtain an active-party encrypted coding result. A passive-party encrypted coding result sent by the passive-party device is received. The passive-party encrypted coding result is obtained by the passive-party device in the following manner: calling the passive-party coding model to code an object feature that is of the object 2 and that is provided by the passive party to obtain a coding result; encrypting the coding result, for example, by using the homomorphic encryption algorithm, to obtain the passive-party encrypted coding result; splicing the active-party encrypted coding result and the passive-party encrypted coding result to obtain a spliced encrypted coding result; and calling the second prediction model to predict the spliced coding result to obtain the second prediction probability.

For example, the passive-party device may pre-call, in an offline state, the passive-party coding model to code object features of all cross objects, then perform encryption, and store an obtained encrypted coding result (such as an encrypted hidden-layer vector) corresponding to each cross object. When an online prediction request of the active-party device is received, only an encrypted coding result that corresponds to a target object and that is required by the prediction request is sent to the active-party device based on an object identifier that is of the target object and that is carried in the prediction request.

For example, the active-party coding model and the passive-party coding model may be DNN models, and the first prediction model and the second prediction model may be machine learning models such as linear regression models, logistic regression models, and gradient boosting tree models.

For example, the active-party device is an electronic device deployed in a game enterprise, and provides an actual game registration probability label of an object and payment behavior features of the object in various games. The passive-party device is an electronic device deployed in an advertising enterprise, and provides interest features of the object to mass advertisements. Relevant data in past seven days is used as a training set, and relevant data in one recent day is used as a test set. Data amounts of the active-party device and the passive-party device are set as follows:

TABLE 1
Data amounts of both parties

| Name | Data amount |
|---|---|
| Pre-training set | 10M |
| Training set | 640K |
| Testing set | 25K |
| Feature type | 89 + 39 |
| Feature dimension | 166 + 298 |
| Positive-negative | 1:13 |
| ratio of labels | |

Table 1 is a schematic table of the amounts of data provided by the active-party device and the passive-party device. In the pre-training phase, the amounts of training data provided by the active-party device and the passive-party device are both 10 megabits (M). The first object features provided by the active-party device are of 89 types and 166 dimensions, and the second object features provided by the passive-party device are of 39 types and 298 dimensions. A ratio of a label data amount corresponding to the positive sample pair to a label data amount corresponding to a negative sample pair is 1 to 13. In the fine-tuning training phase, the amounts of training data provided by the active-party device and the passive-party device are both 640 kilobits (K). In a testing phase, the amounts of training data provided by the active-party device and the passive-party device are both 25 K.

For example, the active-party device is an electronic device deployed in a game enterprise, and provides an actual game registration probability label of an object and payment behavior features of the object in various games. The passive-party device is an electronic device deployed in an enterprise providing a social media service, and provides an object behavior feature extracted from social media content. Relevant data in past seven days is used as a training set, and relevant data in one recent day is used as a test set. Data amounts of the active-party device and the passive-party device are set as follows:

TABLE 2
Data amounts of both parties

| Name | Amount |
|---|---|
| Pre-training set | 10M |
| Training set | 360K |
| Testing Set | 50K |
| Feature type | 51 + 27 |
| Feature dimension | 2122 + 1017 |
| Positive-negative | 1:20 |
| ratio of labels | |

Table 2 is a schematic table of the amounts of data provided by the active-party device and the passive-party device. In the pre-training phase, the amounts of training data provided by the active-party device and the passive-party device are both 10 M. The first object features provided by the active-party device are of 51 types and 2122 dimensions, and the second object features provided by the passive-party device are of 27 types and 1017 dimensions. A ratio of a label data amount corresponding to the positive sample pair to a label data amount corresponding to a negative sample pair is 1 to 20. In the fine-tuning phase, the amounts of training data provided by the active-party device and the passive-party device are both 360 K. In a testing phase, the amounts of training data provided by the active-party device and the passive-party device are both 50 K.

A VFL model is trained by using the data amounts shown in Table 1, and a testing result of the trained VFL model is as follows:

TABLE 3
Testing result 1

| Active party-passive party | AUC | AUC gain |
|---|---|---|
| Input only by the passive party | 0.6603 | — |
| Input only by the active party | 0.7033 | 0 |
| Vertical federated model in the prior art | 0.7230 | 2.8% |
| Vertical federated model in this application | 0.7342 | 4.4% |

Table 3 enumerates the testing result of the VFL model trained based on the data amounts enumerated in Table 1. It can be learned that an area under curve (AUC) value is 0.6603 when only the passive-party device provides object features. An AUC value is when only the active-party device provides object features. The AUC value corresponding to a prediction result of the VFL model in the related art is 0.7230, and the corresponding AUC gain is 2.8%. The AUC value corresponding to a prediction result of the VFL model in the embodiments of this application is 0.7342, and the corresponding AUC gain is 4.4%.

It can be learned that, the AUC value corresponding to the prediction result of the VFL model provided in the embodiments of this application has been improved by 1.6% compared with that of the VFL model in the related art. AUC is a model performance evaluation index for the machine learning model, and a larger AUC value indicates better model performance.

A VFL model is trained by using the data amounts shown in Table 2, and a testing result of the trained VFL model is as follows:

TABLE 4
Testing result 2

| Active party-passive party | AUC | AUC gain |
|---|---|---|
| Input only by the passive party | 0.5871 | — |
| Input only by the active party | 0.6827 | 0 |
| Vertical federated model in the prior art | 0.7375 | 8.0% |
| Vertical federated model in this application | 0.7488 | 9.6% |

Table 4 enumerates the testing result of the VFL model trained based on the data amounts enumerated in Table 2. It can be learned that an AUC value is 0.5871 when only the passive-party device provides object features. An AUC value is 0.6827 when only the active-party device provides object features. The AUC value corresponding to a prediction result of the VFL model in the related art is 0.7375, and the corresponding AUC gain is 8.0%. The AUC value corresponding to a prediction result of the VFL model in the embodiments of this application is 0.7488, and the corresponding AUC gain is 9.6%. It can be learned that, the AUC value corresponding to the prediction result of the VFL model provided in the embodiments of this application has been improved by 1.6% compared with that of the VFL model in the related art.

In the embodiments of this application, contrastive learning-based training is performed in the pre-training phase of the VFL model by using the object features of the cross-objects that are in the sample pair and that are provided by the active-party device and the passive-party device, to make representation of object features of the same object approximate to each other. In the fine-tuning training phase, the pre-trained active-party coding model and passive-party coding model and the initialized second prediction model are used for further training. The first prediction task label reflects whether a plurality of object features are from the same object, and imposes no restriction on the object features used for training, that is, quantities of positive sample pairs and negative sample pairs used for training are very large. Therefore, introducing the first prediction task label that is different from the target prediction task label can expand a training scale and enable the trained machine learning model to have a good generalization capability, to improve accuracy of the prediction result of the machine learning model.

The following continues to describe an exemplary structure in which the machine learning model training apparatus 233 provided in the embodiments of this application is implemented as the software modules. In some embodiments, as shown in FIG. 2A, the software modules in the machine learning model training apparatus 233 stored in the memory 230 may include: the coding module 2331, configured to call an active-party coding model to code a first object feature provided by an active-party device in a sample pair, and encrypt an obtained coding result to obtain an active-party first encrypted coding result, types of sample pairs including a positive sample pair and a negative sample pair; the receiving module 2332, configured to acquire N passive-party first encrypted coding results correspondingly sent by N passive-party devices, N being an integral constant, N≥1, the N passive-party first encrypted coding results being determined based on N passive-party coding models in combination with a second object feature, and the second object feature being an object feature correspondingly provided by the N passive-party devices in the sample pair; the prediction module 2333, configured to splice the active-party first encrypted coding result and the N passive-party first encrypted coding results to obtain a first spliced encrypted coding result, and call a first prediction model to predict the first spliced encrypted coding result to obtain a first prediction probability, the first prediction probability being a probability indicating that the object features in the sample pair are from a same object; the first updating module 2334, configured to perform back propagation based on a first difference between the first prediction probability and a first prediction task label of the sample pair to update parameters of the first prediction model, the active-party coding model, and the N passive-party coding models; and the second updating module 2335, configured to update, by the active-party device and the N passive-party devices, parameters of a second prediction model, the active-party coding model, and the N passive-party coding models based on the positive sample pair and a corresponding second prediction task label, a prediction task of the second prediction model being different from that of the first prediction model.

In the foregoing solution, an n^{th} passive-party first encrypted coding result is obtained by an n^{th} passive-party device in the following manner: calling an n^{th} passive-party coding model to code a second object feature provided by the n^{th} passive-party device in the sample pair, and encrypting an obtained n^{th} passive-party first coding result to obtain an n^{th} passive-party first encrypted coding result, where n is an integral variable and 1≤n≤N.

In the foregoing solution, object features in the positive sample pair are from a same object, and a first prediction task label corresponding to the positive sample pair is a probability being 1; and object features in the negative sample pair are from different objects, and a first prediction task label corresponding to the negative sample pair is a probability being 0.

In the foregoing solution, the first object feature provided by the active-party device in the sample pair is stored in the active-party device, and the second object feature provided by the passive-party device in the sample pair is stored in the passive-party device. The sample pair is processed in batches, and each batch of sample pairs used for training includes K positive sample pairs and L negative sample pairs, where L is an integral multiple of K. The K positive sample pairs include: object features respectively provided by the active-party device and each passive-party device for same K objects, and orders of the K objects in the active-party device and each passive-party device are the same.

In the foregoing solution, the L negative sample pairs are obtained in at least one of the following manners: When the active-party device provides an object feature of a first object, each passive-party device provides an object feature of any object other than the first object in the K objects, where the first object is any one of the K objects. When the active-party device provides an object feature of a first object, each passive-party device provides a spliced object feature, where a dimension of the spliced object feature is the same as that of an object feature of the first object and stored in each passive-party device, the spliced object feature is obtained by each passive-party device by splicing a part of object features of each of K−1 objects, and the K−1 objects are objects other than the first object in the K objects.

In the foregoing solution, the first updating module 2334 is further configured to: substitute the first prediction probability and the first prediction task label of the sample pair into a first loss function for operation to obtain the first difference; perform back propagation based on the first difference to obtain an encrypted first gradient of the parameter of the first prediction model, an encrypted first gradient of the parameter of the active-party coding model, and an encrypted first gradient of the parameter of the N passive-party coding models; update the parameter of the first prediction model and the parameter of the active-party coding model correspondingly based on the encrypted first gradient of the parameter of the first prediction model and the encrypted first gradient of the parameter of the active-party coding model; and send an encrypted first gradient of the parameter of the n^{th} passive-party coding model to the n^{th} passive-party device, where the n^{th} passive-party device updates the parameter of the n^{th} passive-party coding model based on the encrypted first gradient of the parameter of the n^{th} passive-party coding model, where n is an integral variable and 1≤n≤N.

In the foregoing solution, the prediction module 2333 is further configured to send the active-party first encrypted coding result to an intermediate-party device, so that the intermediate-party device performs the following processing in combination with the N passive-party first encrypted coding results sent by the N passive-party devices: splicing the active-party first encrypted coding result and the N passive-party first encrypted coding results to obtain a first spliced encrypted coding result; and calling a first prediction model to predict the first spliced encrypted coding result to obtain a first prediction probability. The first updating module 2334 is further configured to acquire an encrypted first gradient of a parameter of the first prediction model, an encrypted first gradient of a parameter of the active-party coding model, and an encrypted first gradient of a parameter of the N passive-party coding models that are sent by the intermediate-party device, where the encrypted first gradient of the parameter of the first prediction model, the encrypted first gradient of the parameter of the active-party coding model, and the encrypted first gradient of the parameter of the N passive-party coding models are obtained by the intermediate-party device through back propagation based on a first difference between a first prediction probability and a first prediction task label of the sample pair; update the parameter of the first prediction model and the parameter of the active-party coding model correspondingly based on the encrypted first gradient of the parameter of the first prediction model and the encrypted first gradient of the parameter of the active-party coding model; and send the encrypted first gradient of a parameter of the n^{th} passive-party coding model to the n^{th} passive-party device, so that the n^{th} passive-party device updates the parameter of the n^{th} passive-party coding model, where n is an integral variable and 1≤n≤N.

In the foregoing solution, the second updating module 2335 is further configured to: call the active-party coding model to code the first object feature provided by the active-party device in the positive sample pair, and encrypt an obtained coding result to obtain an active-party second encrypted coding result; acquire N passive-party second encrypted coding results correspondingly sent by the N passive-party devices, where the N passive-party second encrypted coding results are determined based on the N passive-party coding models in combination with an object feature correspondingly provided by the N passive-party devices in the positive sample pair; splice the active-party second encrypted coding result and the N passive-party second encrypted coding results to obtain a second spliced encrypted coding result corresponding to the positive sample pair; call the second prediction model to predict the second spliced encrypted coding result corresponding to the positive sample pair to obtain a second prediction probability; and perform back propagation based on a second difference between the second prediction probability and the second prediction task label to update the parameters of the second prediction model, the active-party coding model, and the N passive-party coding models.

In the foregoing solution, the second updating module 2335 is further configured to: substitute the second prediction probability and the second prediction task label into a second loss function for operation to obtain the second difference; perform back propagation based on the second difference to obtain an encrypted second gradient of the parameter of the second prediction model, an encrypted second gradient of the parameter of the active-party coding model, and an encrypted second gradient of the parameter of the N passive-party coding models; update the parameter of the second prediction model and the parameter of the active-party coding model correspondingly based on the encrypted second gradient of the parameter of the second prediction model and the encrypted second gradient of the parameter of the active-party coding model; and send an encrypted second gradient of the parameter of the n^{th} passive-party coding model to the n^{th} passive-party device, where the n^{th} passive-party device updates the parameter of the n^{th} passive-party coding model based on the encrypted second gradient of the parameter of the n^{th} passive-party coding model, where n is an integral variable and 1≤n≤N.

In the foregoing solution, the second updating module 2335 is further configured to send the active-party second encrypted coding result to the intermediate-party device, so that the intermediate-party device performs the following processing in combination with the N passive-party second encrypted coding results sent by the N passive-party devices: splicing the active-party second encrypted coding result and the N passive-party second encrypted coding results to obtain a second spliced encrypted coding result corresponding to the positive sample pair; acquiring an encrypted second gradient of the parameter of the second prediction model, an encrypted second gradient of the parameter of the active-party coding model, and an encrypted second gradient of the parameter of the N passive-party coding models that are sent by the intermediate-party device, where the encrypted second gradient of the parameter of the second prediction model, the encrypted second gradient of the parameter of the active-party coding model, and the encrypted second gradient of the parameter of the N passive-party coding models are obtained by the intermediate-party device through the back propagation based on the second difference between the second prediction probability and the second prediction task label of the positive sample pair; and the second prediction probability is obtained by the intermediate-party device by calling the second prediction model to predict the second spliced encrypted coding result corresponding to the positive sample pair; update the parameter of the second prediction model and the parameter of the active-party coding model correspondingly based on the encrypted second gradient of the parameter of the second prediction model and the encrypted second gradient of the parameter of the active-party coding model; and send an encrypted second gradient of the parameter of the n^{th} passive-party coding model to the n^{th} passive-party device, where the n^{th} passive-party device updates the parameter of the n^{th} passive-party coding model based on the encrypted second gradient of the parameter of the n^{th} passive-party coding model, where n is an integral variable and 1≤n≤N.

The following continues to describe an exemplary structure in which the machine learning model-based prediction apparatus 234 provided in the embodiments of this application is implemented as the software modules. In some embodiments, as shown in FIG. 2B, the software modules in the machine learning model-based prediction apparatus 234 stored in the memory 230 may include: the coding module 2341, configured to call an active-party coding model to code an object feature that is of a target object and that is provided by an active-party device, and encrypt an obtained coding result to obtain an active-party encrypted coding result; the receiving module 2342, configured to acquire N passive-party encrypted coding results correspondingly sent by N passive-party devices, where N being an integral constant, N≥1, and the N passive-party encrypted coding results being determined based on N passive-party coding models in combination with an object feature that is of the target object and that is correspondingly provided by the N passive-party devices; the splicing module 2343, configured to splice the active-party encrypted coding result and the N passive-party encrypted coding results to obtain a spliced encrypted coding result; and the prediction module 2344, configured to call a second prediction model to predict the spliced encrypted coding result to obtain a second prediction probability, the active-party coding model, the N passive-party coding models, and the second prediction model being trained according to the foregoing machine learning model training method.

In the foregoing solution, an n^{th} passive-party encrypted coding result is sent by an n^{th} passive-party device in response to a prediction request of the active-party device, and the prediction request of the active-party device carries an object identifier of the target object. The n^{th} passive-party encrypted coding result is obtained in the following manner: calling an n^{th} passive-party coding model to code an object feature that is of the target object and that is provided by the n^{th} passive-party device, and encrypting an obtained n^{th} passive-party coding result to obtain the n^{th} passive-party encrypted coding result, where N is an integral variable and 1≤n≤N.

An embodiment of this application provides a computer program product or a computer program, the computer program product or the computer program including computer instructions, and the computer instructions being stored in a computer-readable storage medium. A processor of an electronic device reads the computer instructions from the computer-readable storage medium, and executes the computer instructions, so that the electronic device performs the foregoing machine learning model training method or machine learning model-based prediction method provided in the embodiments of this application.

An embodiment of this application provides a computer-readable storage medium storing executable instructions, when being executed by a processor, the executable instructions causing the processor to execute the machine learning model training method or the machine learning model-based prediction method provided in the embodiments of this application.

In some embodiments, the computer-readable storage medium may be a memory such as an FRAM, a ROM, a PROM, an EPROM, an EEPROM, a flash memory, a magnetic surface memory, a compact disc, or a CD-ROM, or may be various devices that include one or any combination of the foregoing memories.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. In some embodiments, the executable instructions may be in a form of a program, software, a software module, a script, or code, may be written in any form of programming language (including a compiled or interpreted language or a declarative or procedural language), and may be deployed in any form, including being deployed as an independent program or being deployed as a module, a component, a subroutine, or another unit suitable for use in a computing environment.

For example, the executable instructions may be deployed to be executed on a single electronic device, on a plurality of electronic devices at a single location, or on a plurality of electronic devices distributed across a plurality of locations and interconnected via a communication network.

In conclusion, in the embodiments of this application, the first prediction model is trained by using the second object feature provided by the active-party device and the passive-party device in the sample pair. Because the first prediction probability obtained through prediction using the first prediction model is the probability indicating that the object features in the sample pair are from the same object, the first prediction model can make representation of object features of the same object in the active-party device and the passive-party device approximate to each other. Because the prediction task of the first prediction model is different from that of the second prediction model, the first prediction task label is also different from the second prediction task label. The first prediction task label reflects whether a plurality of object features are from the same object, and imposes no restriction on the object features used for training, that is, quantities of positive sample pairs and negative sample pairs used for training are very large. Therefore, introducing the first prediction task label that is different from the target prediction task label can expand the training scale and enable the trained machine learning model to have the good generalization capability, to improve the accuracy of the prediction result of the machine learning model.

The foregoing descriptions are merely embodiments of this application and are not intended to limit the protection scope of this application. Any modification, equivalent replacement, improvement, or the like made without departing from the spirit and scope of this application shall fall within the protection scope of this application.

What is claimed is:

1. A machine learning model training method performed by a computer device acting as an active-party device, the method comprising:
coding and encrypting a first object feature in a plurality of sample pairs provided by the active-party device using an active-party coding model to obtain an active-party first encrypted coding result, the plurality of sample pairs comprising a set of positive sample pairs and a set of negative sample pairs;
acquiring N passive-party first encrypted coding results correspondingly sent by N passive-party devices, N being an integral constant, N≥1, the N passive-party first encrypted coding results being determined based on N passive-party coding models in combination with a second object feature in the plurality of sample pairs provided by the N passive-party devices;
splicing the active-party first encrypted coding result and the N passive-party first encrypted coding results to obtain a first spliced encrypted coding result, and applying the first spliced encrypted coding result to a first prediction model to obtain a first prediction probability, the first prediction probability being a probability indicating that the first and second object features in each of the plurality of sample pairs are from a same object;
performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices; and
causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model.

2. The method according to claim 1, wherein an n^{th} passive-party first encrypted coding result is obtained by an n^{th} passive-party device in the following manner:
coding the second object feature in the plurality of sample pairs provided by the n^{th} passive-party device using calling an n^{th} passive-party coding model; and
encrypting the n^{th} passive-party first coding result to obtain the n^{th} passive-party first encrypted coding result, wherein n is an integral variable and 1≤n≤N.

3. The method according to claim 1, wherein
object features in each of the set of positive sample pairs are from a same object, and a first prediction task label corresponding to the each of the set of positive sample pairs is a probability of 1; and
object features in each of the set of negative sample pairs are from different objects, and a first prediction task label corresponding to the each of the set of negative sample pairs is a probability of 0.

4. The method according to claim 1, wherein the performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices comprises:
performing back propagation based on the first difference to obtain an encrypted first gradient of the parameters of the first prediction model, an encrypted first gradient of the parameters of the active-party coding model, and an encrypted first gradient of a respective one of the parameters of the N passive-party coding models;
updating the parameters of the first prediction model and the parameters of the active-party coding model correspondingly based on the encrypted first gradient of the parameters of the first prediction model and the encrypted first gradient of the parameters of the active-party coding model; and
sending an encrypted first gradient of a parameter of an n^{th} passive-party coding model to an n^{th} passive-party device, wherein the n^{th} passive-party device updates the parameter of the n^{th} passive-party coding model based on the encrypted first gradient of the parameter of the n^{th} passive-party coding model, wherein
n is an integral variable and 1≤n≤N.

5. The method according to claim 1, wherein the causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model comprises:
repeating the aforementioned steps recited in claim 1 to the set of positive sample pairs to obtain a second spliced encrypted coding result corresponding to the set of positive sample pairs;
applying the second spliced encrypted coding result corresponding to the set of positive sample pairs to the second prediction model to obtain a second prediction probability; and
performing back propagation based on a second difference between the second prediction probability and the second prediction task label to cause an update of the parameters of the second prediction model and the active-party coding model by the active-party device and respective updates of the N passive-party coding models by the corresponding N passive-party devices.

6. The method according to claim 5, wherein the performing back propagation based on a second difference between the second prediction probability and the second prediction task label to cause an update of the parameters of the second prediction model and the active-party coding model by the active-party device and respective updates of the N passive-party coding models by the corresponding N passive-party devices comprises:
substituting the second prediction probability and the second prediction task label into a second loss function for operation to obtain the second difference;
performing back propagation based on the second difference to obtain an encrypted second gradient of the parameters of the second prediction model, an encrypted second gradient of the parameters of the active-party coding model, and an encrypted second gradient of a respective one of the parameters of the N passive-party coding models;
updating the parameters of the second prediction model and the parameters of the active-party coding model correspondingly based on the encrypted second gradient of the parameters of the second prediction model and the encrypted second gradient of the parameters of the active-party coding model; and
sending an encrypted second gradient of a parameter of an n^{th} passive-party coding model to an n^{th} passive-party device, wherein the n^{th} passive-party device updates the parameters of the n^{th} passive-party coding model based on the encrypted second gradient of the parameter of the n^{th} passive-party coding model, wherein
n is an integral variable and 1≤n≤N.

7. The method according to claim 1, further comprising:
receiving a target object; and
applying the target object to the active-party coding model, the N passive-party coding models, and the second prediction model to obtain a prediction probability of the target object, wherein the prediction probability corresponds to a commodity purchase intention of the target object.

8. The method according to claim 7, wherein an n^{th} passive-party encrypted coding result is sent by an n^{th} passive-party device in response to a prediction request of the active-party device, and the prediction request of the active-party device carries an object identifier of the target object.

9. A computer device acting as an active-party device, the computer device comprising:
a memory, configured to store executable instructions; and
a processor, configured to implement, when executing the executable instructions stored in the memory, a machine learning model training method including:
coding and encrypting a first object feature in a plurality of sample pairs provided by the active-party device using an active-party coding model to obtain an active-party first encrypted coding result, the plurality of sample pairs comprising a set of positive sample pairs and a set of negative sample pairs;
acquiring N passive-party first encrypted coding results correspondingly sent by N passive-party devices, N being an integral constant, N≥1, the N passive-party first encrypted coding results being determined based on N passive-party coding models in combination with a second object feature in the plurality of sample pairs provided by the N passive-party devices;
splicing the active-party first encrypted coding result and the N passive-party first encrypted coding results to obtain a first spliced encrypted coding result, and applying the first spliced encrypted coding result to a first prediction model to obtain a first prediction probability, the first prediction probability being a probability indicating that the first and second object features in each of the plurality of sample pairs are from a same object;
performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices; and
causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model.

10. The computer device according to claim 9, wherein an n^{th} passive-party first encrypted coding result is obtained by an n^{th} passive-party device in the following manner:
coding the second object feature in the plurality of sample pairs provided by the n^{th} passive-party device using calling an n^{th} passive-party coding model; and
encrypting the n^{th} passive-party first coding result to obtain the n^{th} passive-party first encrypted coding result, wherein n is an integral variable and 1≤n≤N.

11. The computer device according to claim 9, wherein
object features in each of the set of positive sample pairs are from a same object, and a first prediction task label corresponding to the each of the set of positive sample pairs is a probability of 1; and
object features in each of the set of negative sample pairs are from different objects, and a first prediction task label corresponding to the each of the set of negative sample pairs is a probability of 0.

12. The computer device according to claim 9, wherein the performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices comprises:
performing back propagation based on the first difference to obtain an encrypted first gradient of the parameters of the first prediction model, an encrypted first gradient of the parameters of the active-party coding model, and an encrypted first gradient of a respective one of the parameters of the N passive-party coding models;
updating the parameters of the first prediction model and the parameters of the active-party coding model correspondingly based on the encrypted first gradient of the parameters of the first prediction model and the encrypted first gradient of the parameters of the active-party coding model; and
sending an encrypted first gradient of a parameter of an n^{th} passive-party coding model to an n^{th} passive-party device, wherein the n^{th} passive-party device updates the parameter of the n^{th} passive-party coding model based on the encrypted first gradient of the parameter of the n^{th} passive-party coding model, wherein
n is an integral variable and 1≤n≤N.

13. The computer device according to claim 9, wherein the causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model comprises:
repeating the aforementioned steps recited in claim 1 to the set of positive sample pairs to obtain a second spliced encrypted coding result corresponding to the set of positive sample pairs;
applying the second spliced encrypted coding result corresponding to the set of positive sample pairs to the second prediction model to obtain a second prediction probability; and
performing back propagation based on a second difference between the second prediction probability and the second prediction task label to cause an update of the parameters of the second prediction model and the active-party coding model by the active-party device and respective updates of the N passive-party coding models by the corresponding N passive-party devices.

14. The computer device according to claim 13, wherein the performing back propagation based on a second difference between the second prediction probability and the second prediction task label to cause an update of the parameters of the second prediction model and the active-party coding model by the active-party device and respective updates of the N passive-party coding models by the corresponding N passive-party devices comprises:
substituting the second prediction probability and the second prediction task label into a second loss function for operation to obtain the second difference;
performing back propagation based on the second difference to obtain an encrypted second gradient of the parameters of the second prediction model, an encrypted second gradient of the parameters of the active-party coding model, and an encrypted second gradient of a respective one of the parameters of the N passive-party coding models;
updating the parameters of the second prediction model and the parameters of the active-party coding model correspondingly based on the encrypted second gradient of the parameters of the second prediction model and the encrypted second gradient of the parameters of the active-party coding model; and
sending an encrypted second gradient of a parameter of an n^{th} passive-party coding model to an n^{th} passive-party device, wherein the n^{th} passive-party device updates the parameters of the n^{th} passive-party coding model based on the encrypted second gradient of the parameter of the n^{th} passive-party coding model, wherein
n is an integral variable and 1≤n≤N.

15. The computer device according to claim 9, wherein the method further comprises:
receiving a target object; and
applying the target object to the active-party coding model, the N passive-party coding models, and the second prediction model to obtain a prediction probability of the target object, wherein the prediction probability corresponds to a commodity purchase intention of the target object.

16. The computer device according to claim 15, wherein an n^{th} passive-party encrypted coding result is sent by an n^{th} passive-party device in response to a prediction request of the active-party device, and the prediction request of the active-party device carries an object identifier of the target object.

17. A non-transitory computer-readable storage medium, storing executable instructions, the executable instructions, when executed by a processor of a computer device acting as an active-party device, implementing a machine learning model training method including:
coding and encrypting a first object feature in a plurality of sample pairs provided by the active-party device using an active-party coding model to obtain an active-party first encrypted coding result, the plurality of sample pairs comprising a set of positive sample pairs and a set of negative sample pairs;
acquiring N passive-party first encrypted coding results correspondingly sent by N passive-party devices, N being an integral constant, N≥1, the N passive-party first encrypted coding results being determined based on N passive-party coding models in combination with a second object feature in the plurality of sample pairs provided by the N passive-party devices;
splicing the active-party first encrypted coding result and the N passive-party first encrypted coding results to obtain a first spliced encrypted coding result, and applying the first spliced encrypted coding result to a first prediction model to obtain a first prediction probability, the first prediction probability being a probability indicating that the first and second object features in each of the plurality of sample pairs are from a same object;
performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices; and
causing an update of parameters of a second prediction model and the active-party coding model by the active-party device and respective updates of the N passive-party coding models by the corresponding N passive-party devices based on the set of positive sample pairs and a corresponding second prediction task label, wherein a prediction task of the second prediction model is different from that of the first prediction model.

18. The non-transitory computer-readable storage medium according to claim 17, wherein object features in each of the set of positive sample pairs are from a same object, and a first prediction task label corresponding to the each of the set of positive sample pairs is a probability of 1; and
object features in each of the set of negative sample pairs are from different objects, and a first prediction task label corresponding to the each of the set of negative sample pairs is a probability of 0.

19. The non-transitory computer-readable storage medium according to claim 15, wherein performing back propagation based on a first difference between the first prediction probability and a first prediction task label of the plurality of sample pairs to cause an update of parameters of the first prediction model and the active-party coding model by the active-party device and respective updates of the N passive-party coding models by the corresponding N passive-party devices comprises:
performing back propagation based on the first difference to obtain an encrypted first gradient of the parameters of the first prediction model, an encrypted first gradient of the parameters of the active-party coding model, and an encrypted first gradient of a respective one of the parameters of the N passive-party coding models;
updating the parameters of the first prediction model and the parameters of the active-party coding model correspondingly based on the encrypted first gradient of the parameters of the first prediction model and the encrypted first gradient of the parameters of the active-party coding model; and
sending an encrypted first gradient of a parameter of an n^{th} passive-party coding model to an n^{th} passive-party device, wherein the n^{th} passive-party device updates the parameter of the n^{th} passive-party coding model based on the encrypted first gradient of the parameter of the n^{th} passive-party coding model, wherein
n is an integral variable and 1≤n≤N.

20. The non-transitory computer-readable storage medium according to claim 17, wherein the method further comprises:
receiving a target object; and
applying the target object to the active-party coding model, the N passive-party coding models, and the second prediction model to obtain a prediction probability of the target object, wherein the prediction probability corresponds to a commodity purchase intention of the target object.
